(19) United States
(12) Patent Application Publication
(10) Pub. No.: US 2006/0277130 A1
(43) Pub. Date: Dec. 7, 2006

(54) METHODS AND APPARATUS TO PREDICT DEMAND FOR A PRODUCT OR SERVICE

(75) Inventor: Richard M. Harmon, Lake Forest, IL (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: The Ticket Reserve, Inc.

(21) Appl. No.: 11/380,186

(22) Filed: Apr. 25, 2006

Related U.S. Application Data
(60) Provisional application No. 60/674,866, filed on Apr. 25, 2005.

(51) Int. Cl. G06Q 40/00

(52) U.S. Cl. 705/35

(57) ABSTRACT

Methods and apparatus to predict demand for a product or service (e.g., music concerts, toys, etc.) are disclosed. A futures market is opened for the particular good or service, and market data is generated. The producer of the product or service makes a production decision based on that market data.

### CROSS REFERENCE TO RELATED APPLICATION

The subject application claims priority to U.S. Provisional application 60/674,866.

### TECHNICAL FIELD

The present invention relates generally to contingent event certificates, and, in particular to methods and apparatus for predicting demand based on the sale of contingent event certificates. The present invention may be applied to an electronic exchange and method for trading contingent event certificates that relate to any number of events, or series of events taking place at a venue such as a sports stadium or theater.

### BACKGROUND

Typically, tickets for sporting events, concerts, theatrical performances, and the like, are sold to the public in advance of the event at a predetermined face value. Often, however, the face value of a ticket does not accurately reflect the true value of the ticket. Namely, the face value of the ticket does not reflect the actual price people are willing to pay to attend the event. For high demand events, such as the Super Bowl, World Series or other championship and playoff games, or concerts by popular entertainers, fans are often willing to spend many times the face value of a ticket in order to attend the event.

This excess demand has created a large secondary market for major event tickets. Often ticket “scalpers,” brokers, and other speculators will purchase large blocks of tickets at face value and resell the tickets at whatever price the secondary market will bear. Often these sales include a large profit. Even fans who are not in the business of profiting from inflated ticket prices will sometimes “cash-in” if the ticket resale price is driven so high that it exceeds their interest in attending the event. However, individuals who do not regularly participate in this secondary market typically have a more difficult time determining the market value of tickets they are trying to purchase, or trying to sell. It will often take many contacts with several brokers, scalpers, or other individuals to determine the going rate for event tickets. In some cases, ticket holders who wish to sell their tickets must actually travel to the event venue itself in hopes of connecting with others who have also come to the venue in hopes of purchasing tickets. This method of making a market is time consuming and inefficient.

In addition to the inefficiencies of such an unsanctioned, organically developed secondary market, the very existence of such a market represents lost revenue to the parties responsible for producing the event, namely the team owners, the leagues, promoters, producers, and the like (collectively the event producer or event producers). When a fan pays $500.00 to a scalper for a ticket having a $120.00 face value, the fan pays an additional $380 for the producer's product. The producer sees none of this additional value. It is in the producer's interest to realize at least a portion of the additional value of tickets for high demand events, either by more appropriately setting the face value of the tickets, or by somehow participating in the secondary market.

In addition to individual event tickets, event producers will often sell tickets in a package for a series of related events. For example, sports team owners sell season ticket packages. Symphonies and opera companies offer patrons subscription series to their season's performances. Such ticket packages include individual event tickets for some or all of the events the team or performance company will perform at their home venue, be it a ball park, theater, concert hall or the like. Typically the individual tickets associated with such packages will be for the same seat within the venue for each event.

A problem that sometimes arises for season ticket holders is that the ticket holder is unable to attend all of the individual events. In such cases the ticket holder is left holding a ticket that has no value to the ticket holder, but which may be highly coveted by another fan. The season ticket holder unable to use the ticket would obviously like to sell the unusable ticket to someone who can attend the event. Not only would the ticket holder like to sell the ticket to a fan desiring to attend the event, the ticket holder would like to sell the ticket to the fan most desirous of attending the event in order to receive the highest price possible. However, making the connection between the season ticket holder and that most desirous fan is no simple matter. Creating an accessible marketplace where ticket buyers and sellers can easily find one another would likely increase the value of season or series ticket packages since the purchasers of such packages would know that, in the event that some tickets are not used, the season ticket holder can easily sell the unusable tickets to recoup at least a portion of the cost of the package.

Another recent development that impacts the availability of tickets and the price of tickets in secondary ticket markets is the advent of the permanent seat license, or PSL. PSLs are generally an extension of the season ticket concept. They are most often sold in conjunction with efforts to raise money for the construction of new venues such as new sports stadiums, although they can be sold for existing venues as well. A typical PSL grants the licensee the right to purchase season tickets for a particular seat in the venue every season. The PSL may extend for a limited number of seasons, such as ten seasons, for example, or the PSL may continue in perpetuity. In some cases the licensee is obligated to purchase the season tickets each season depending on the conditions of the license.

Because the PSL allows and in some cases obligates the licensee to purchase season tickets each season, the same difficulties regarding unusable tickets within a season ticket package described above apply to PSLs. Thus, an accessible market for trading event tickets would benefit PSL licensees in the same manner as it would traditional season ticket holders, thereby increasing the value of PSLs. Because of the multi-season nature of PSLs, their appeal may be somewhat limited. For example, a PSL which obligates the licensee to purchase season tickets annually for 10 years may not appeal to a fan who likely will be required to move to another market in less than 10 years. If however, such a fan is allowed to sell the unexpired term of such a PSL when he or she leaves the area, the fan may be more likely to buy the PSL in the first place, knowing that he or she may be able to recover at least a portion of the cost of the PSL by selling the unexpired term. Thus, a market that allows trading in PSLs would also likely increase the value of PSLs.

A final aspect of the secondary ticket market that affects the profits realized by event producers is the demand for tickets to events that may (or may not) be scheduled in the future. The most common example of this is the market for sporting event playoff and championship games. At the beginning of a season a local team's prospects for making the end of season playoffs or of being in the championship game may not be too promising. Therefore, at the beginning of the season demand for playoff or championship game tickets will be low, since such games are unlikely ever to occur. If the team performs well during the course of the season, however, the chances that such playoff games, or a championship game with the local team participating may steadily increase. Thus, demand for potential playoff or championship game tickets will increase as well.

Various event producers handle the distribution of tickets for such contingent events in different ways. For example, some event producers will require PSL and season ticket holders to purchase event tickets if and when the event becomes a reality. Other event producers may grant PSL and season ticket holders a right of first refusal to purchase such tickets when the event is scheduled. Finally, other event producers will sell tickets to the newly scheduled events independently of the PSL and season ticket offerings. Regardless of the mechanism by which the event tickets are offered to the public, the event producers can profit by somehow participating in the secondary ticket market. Further, for those event producers who associate the sale of e.g., post-season event tickets with season ticket packages and PSLs, providing a market for reselling contingent event tickets will help increase the value of the season ticket packages and the PSLs.

### SUMMARY OF THE INVENTION

The present invention relates to methods and apparatus for predicting demand based on the sale of contingent event certificates. The present invention may be applied to an electronic exchange and method for trading permanent seat licenses, ticket events, and contingent event certificates that relate to any number of events, or series of events taking place at a venue such as a sports stadium or theater.

In one preferred embodiment, inventory traded on the exchange is limited to PSLs and the event tickets associated with PSLs, as well as contingent event ticket certificates which may or may not be associated with PSLs. The exchange provides a mechanism whereby individuals holding inventory in the form of PSLs, event tickets or contingent event tickets may post offers to sell some or all of their holdings at a specified price. The exchange also provides a mechanism whereby individuals desiring to buy PSLs, event tickets or contingent event tickets may post bids to purchase specific items at a specified price. Such bids and offers are made available to all members of the exchange so that those interested in the specific inventory which is being offered for sale or which is being bid on can determine the market value of such inventory.

Those members of the exchange willing to buy inventory which has been offered for sale may accept an offer at the specified price, or may submit a bid below the offering price. Similarly, those individuals holding inventory corresponding to a submitted bid may accept the bid and sell the inventory at the bid price. Alternatively, the inventory owner may submit an offer to sell at a price above the current bid price. The exchange matches offers and bids with indications of accepting the offers and bids, transfers the inventory between the buyer and seller, and charges the buyer an amount corresponding to the accepted offer or bid and credits the seller an amount corresponding to the accepted offer or bid. Thus, buyers and sellers need only deal with the exchange, not directly with one another.

The system provides an electronic exchange for trading PSLs, event tickets and contingent event ticket certificates. The electronic exchange includes a web server accessible by an unlimited number of buyers and sellers over a network, the web server is adapted to provide an exchange interface to the buyers' and sellers' computer terminals over the network to be displayed by the buyers' and sellers' network browsers. The interface is configured to transmit user commands entered by the buyers and sellers to the exchange for submitting offers to sell inventory, bids to purchase inventory as well as indications of the acceptance of offers to sell and bids to purchase inventory. A database maintains records of all members of the exchange as well as a record of all inventory traded on the exchange. A matching engine, which may or may not be running on the same platform as the web server, matches the acceptance of offers to sell and bids to purchase inventory with the offers and bids themselves. The matching engine then initiates a transaction wherein ownership of the subject inventory is transferred from the seller to the buyer. This is accomplished by altering the inventory records stored in the database. The matching engine further initiates a transaction wherein the buyer is charged an amount corresponding to the accepted bid or offer, and the seller is credited a similar amount.

The method of trading permanent seat licenses, event tickets and contingent event ticket certificates disclosed herein includes the steps of receiving offers to sell such inventory as well as bids to purchase inventory. Once such offers and bids are received they are communicated to the members of the exchange who are the potential buyers and sellers of the inventory specified in the various bids and offers received. The next step in the inventive method involves receiving corresponding indications that the bids and offers have been accepted by other members of the exchange. The corresponding indications of the acceptance of the bids and offers are matched to the respective bids and offers. A transaction is then initiated whereby ownership of the subject inventory is transferred from the seller to the buyer, the buyer is charged an amount related to the bid or offered amount, and the seller is credited a similar amount.

In another embodiment, a method for executing a payment transaction is provided. The method includes steps of creating an electronic marketplace for the sale of items and registering users for the electronic marketplace. Registered users are then able to offer items for sale at an offer price. The user offering the item for sale assigns the offer price for the item. The items offered for sale are then displayed in the electronic marketplace at their respective user-assigned prices. When a seller's offer price is accepted by a purchaser, a payment transaction is automatically completed between the seller and the purchaser. The seller thus sells the item at its user-assigned offer price to the purchaser.

The method may further include the step of enabling the purchaser to re-sell the respective sale item in the electronic marketplace at a user-assigned price. In this manner, the item can be resold any number of different times by a number of different users at a number of different offer prices.

The step of completing the payment transaction may include charging the purchaser in an amount related to the user-assigned offer price for the respective sale item and crediting the seller in an amount related to the user-assigned offer price for the respective sale item. In one embodiment, at least one of a credit card, a financial account, and an electronic marketplace account of the purchaser is debited, while at least one of a credit card, a financial account, and an electronic marketplace account (collectively referred to as “financial account”) of the seller is credited. Thus, the step of automatically completing the payment transaction includes automatically exchanging payment between the purchaser and the exchange, and the exchange and the seller via a predetermined financial instrument or account.

In one embodiment, the step of completing the payment transaction also includes paying a marketplace transaction fee. The marketplace transaction fee is preferably paid to the administrator of the electronic marketplace, thereby generating revenue for the administrator. In an alternative embodiment, the marketplace transaction fee includes an originator merchant fee. The originator merchant fee is paid to an originator merchant who originates the first sale of the respective sale item. For example, where the item being sold is a personal seat license, a contingent event ticket certificate or an event ticket, the originator merchant would most likely be an event promoter, a facility owner, or a sports franchise. According to this embodiment, the originator merchant receives a payment for each transaction in which one of their original items is subsequently resold.

In one embodiment, the item is a ticket such as an event ticket or a travel ticket. In another embodiment, the item is a contingent event ticket certificate. A contingent event certificate may give the right to purchase any type of good or service if the contingent event occurs. Examples of such items include sporting events, concerts, plays, toys, cars, real estate, memorabilia, personal seat licenses, hotel reservations, airline tickets, travel packages, etc.

In one embodiment, methods and apparatus to predict demand for a product or service (e.g., music concerts, toys, etc.) are disclosed. A futures market is opened for the particular good or service, and market data is generated. The producer of the product or service makes a production decision based on that market data.

The methods and apparatus of the present invention enables purchasers to buy an option to attend an event that may or may not occur in the future. The purchaser can buy the option for a minimal fee. This option will then guarantee the purchaser the right to buy a ticket if the event becomes certain. Thus, once the event is scheduled, the purchaser has the right to buy an actual event ticket. This allows consumers to voice their preferences to the event producers which will encourage consumers to attend events. Consumers will feel connected to the event. Consumers will also not have to worry about long ticket lines, busy telephone lines, coordinating schedules to purchase tickets in advance, or dealing with scalpers and brokers.

In one embodiment of the present invention, the cost of the option will be refunded to the consumer if the event is never actually scheduled. In the manner, there is no risk of losing money to the consumer.

The methods and apparatus of the present invention allows an event producer or seller to predict the demand in the market for the product or service being offered. Different variables can be provided for the event (e.g., venue, performer, city, dream event) which allows purchasers and fans in the market to choose the variables based on their preferences. This captures valuable data from fans for every variable offered by the event producers or seller. The true demand of the market is accurate and comprehensive. Additionally, revenue is generated from the sales of options and supersedes the broker market In this manner, the uncertainty or risk associated with low ticket sales is removed.

The present invention can be applied to an electronic exchange and method for trading PSLs, event tickets, and contingent event certificates. The electronic exchange accesses a large number of consumers from different markets. This advantage makes it economically feasible to collect an extensive amount of data from different consumer bases and markets.

In one embodiment, purchasers can also buy parking, travel and lodging associated with the future option being purchased. This enables a purchaser of an option to organize and secure the details surrounding the event before the event is actually scheduled. In the manner, the purchaser does not have to be concerned with last minute prices or mark-ups.

In one embodiment, a portion of the revenue collected from the future options sold are donated to charity. In this manner, purchasers are encouraged to participate. In another embodiment, the sale of future options can be promoted by the sale of merchandise and music associated with the event. In this manner, the event is being promoted and purchasers are motivated to buy future options.

Advantage of the present invention for event producers and sellers is the ability to do the following: deliver a targeted and guaranteed product or event, capture valuable and new information about fans and consumer base, enhance fan interaction and excitement, deflate and replace the secondary market, cross sell products and services, and reduce risk of upfront fees and costs.

Advantages of the present invention for purchasers and fans is the ability to do the following: attain forward access to a special event, help define an event and its location, create an event according to their preferences, achieve a sense of empowerment, interact in secure and reliable transactions, disregard secondary market, and actively participate in preferred event.

### BRIEF DESCRIPTION OF THE DRAWINGS

Additional features and advantages of the present invention will be apparent from the following detailed discussion of the invention made with reference to the drawings annexed hereto in which like reference characters refer to like elements and in which:

FIG. 1 is a flow chart of a method of trading PSLs, event tickets, and/or contingent event ticket certificates in accordance with a preferred embodiment of the present invention;

FIG. 2 is a plan view of a venue showing various seating zones in accordance with a preferred embodiment of the present invention;

FIG. 3 is a schematic block diagram of an exchange for trading PSLs, event tickets and contingent event ticket certificates in accordance with the present invention in accordance with a preferred embodiment of the present invention;

FIG. 4 is a block diagram of a network based exchange in accordance with a preferred embodiment of the present invention;

FIG. 5 is a screen shot of a graphical user interface for an exchange showing a login page in accordance with a preferred embodiment of the present invention;

FIG. 6 is a screen shot of a graphical user interface for an exchange showing a customized customer page showing seat license holdings of a PSL owner in accordance with a preferred embodiment of the present invention;

FIG. 7 is a screen shot of a graphical user interface for an exchange showing a customized customer page showing event ticket holdings of a PSL owner in accordance with a preferred embodiment of the present invention;

FIG. 8 is a screen shot of a graphical user interface for an exchange showing a new order page in accordance with a preferred embodiment of the present invention;

FIG. 9 is a screen shot of a graphical user interface for an exchange showing a customized customer page showing submitted orders in accordance with a preferred embodiment of the present invention;

FIG. 10 is a screen shot of a graphical user interface for an exchange showing a customized customer page of a customer having no holdings in accordance with a preferred embodiment of the present invention;

FIG. 11 is a screen shot of a graphical user interface for an exchange showing a purchase event tickets page in accordance with a preferred embodiment of the present invention;

FIG. 12 is a screen shot of a graphical user interface for an exchange showing a more detailed purchase ticket page in accordance with a preferred embodiment of the present invention;

FIG. 13 is a screen shot of a graphical user interface for an exchange showing a purchase event tickets invoice page in accordance with a preferred embodiment of the present invention;

FIG. 14 is a screen shot of a graphical user interface for an exchange showing a customized customer page showing the event ticket holdings of an event ticket trader in accordance with a preferred embodiment of the present invention;

FIG. 15 is a screen shot of a graphical user interface for an exchange showing an event ticket purchase/sell event tickets page in accordance with a preferred embodiment of the present invention;

FIG. 16 is a screen shot of a graphical user interface for an exchange showing an event tickets sales invoice page in accordance with a preferred embodiment of the present invention;

FIG. 17 is a screen shot of a graphical user interface for an exchange showing a bid acceptance message page in accordance with a preferred embodiment of the present invention;

FIG. 18 is a screen shot of a graphical user interface for an exchange showing a customized customer page showing an event ticket purchaser's event ticket holdings in accordance with a preferred embodiment of the present invention;

FIG. 19 is a screen shot of a graphical user interface for an exchange showing an event tickets transfer page in accordance with a preferred embodiment of the present invention;

FIG. 20 is a screen shot of a graphical user interface for an exchange showing a ticket transfer e-mail message sent to an event ticket transferee in accordance with a preferred embodiment of the present invention;

FIG. 21 is a screen shot of a graphical user interface for an exchange showing a customized customer page showing an event tickets transferee's ticket holdings in accordance with a preferred embodiment of the present invention;

FIG. 22 is a screen shot of a graphical user interface for an exchange showing a screen shot of two event ticket coupons ready to be printed and used to gain access to the venue for the specified event in accordance with a preferred embodiment of the present invention;

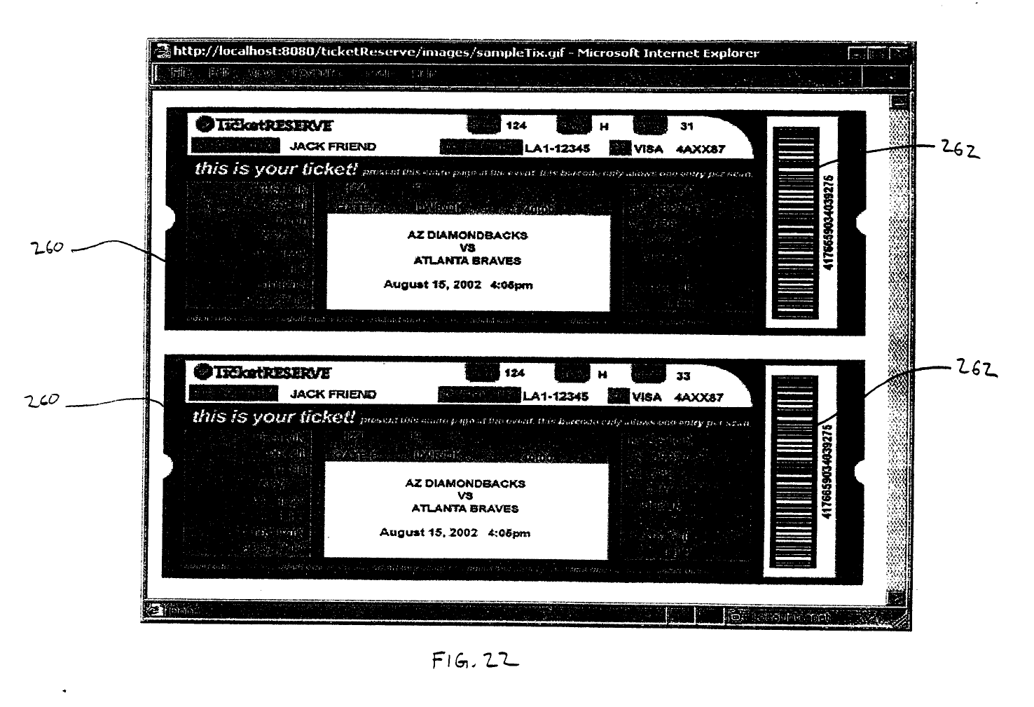

FIG. 23 is a flow chart of a method for executing a payment transaction in accordance with a preferred embodiment of the present invention;

FIG. 24 is an example of a payment transaction stream in accordance with a preferred embodiment of the present invention;

FIG. 25 is a block diagram showing a system for executing a payment transaction in accordance with a preferred embodiment of the present invention;

FIG. 26 is a flow chart of another method for executing a payment transaction in accordance with a preferred embodiment of the present invention;

FIG. 27 is a flow chart of one other method for executing a payment transaction in accordance with a preferred embodiment of the present invention; and

FIG. 28 is a flow chart of a method for to predict demand for a product or service in accordance with a preferred embodiment of the present invention;

It should be noted that the drawings are only intended to facilitate the description of the preferred embodiments of the present invention. The figures do not describe every aspect of the present invention and do not limit the scope of the invention.

### DETAILED DESCRIPTION OF THE INVENTION

The present system relates to a market for trading permanent seat licenses (PSLs), individual event tickets, and/or contingent event ticket certificates for various events, such as sporting events, concerts, and the like which are scheduled to take place, or may in the future be scheduled to take place at a designated venue. The system provides both a method of trading such products and an electronic exchange for facilitating such trades.

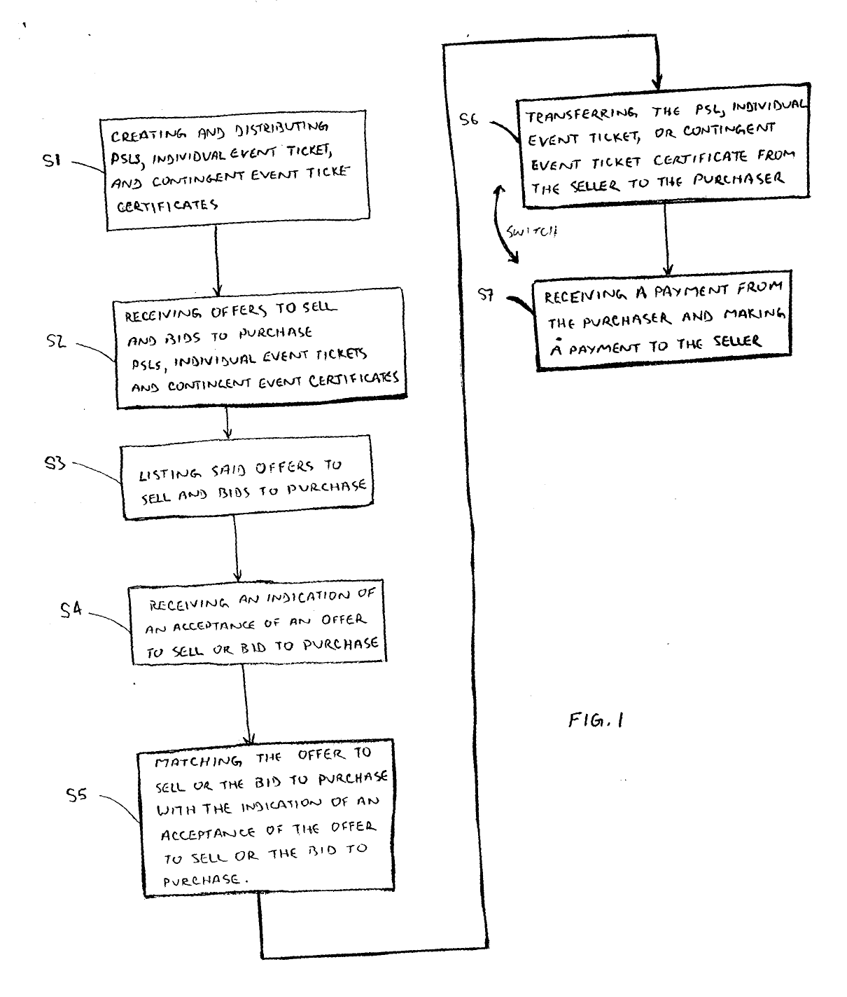

Referring first to FIG. 1, a method is disclosed for trading PSLs, event tickets and/or contingent event ticket certificates in accordance with a preferred embodiment of the present invention. Step S1 calls for creating and distributing an inventory of PSLs, individual event tickets, and contingent event ticket certificates. Contingent event tickets are a novel product created in accordance with the present system. A contingent event ticket certificate represents the right and obligation to purchase an event ticket at face value for an event that may (or may not) be scheduled in the future. According to an embodiment of the system, whoever is the holder of record of a contingent event ticket certificate when the contingent event is scheduled and tickets for the event go on sale, is automatically billed for the face value of the ticket. If the contingent event ticket certificate holder has agreed to pay by credit card, debit card, or electronic fund transfer (or the like) the designated financial account is automatically charged. In order to facilitate electronic trading of PSLs, event tickets, and contingent event ticket certificates, it is preferred that the initial distribution of tickets and contingent event ticket certificates is performed electronically so that a database may be maintained of all tickets and contingent event ticket certificates in the inventory, the current owner of each ticket or contingent event ticket certificate, and an audit trail of all previous owners going back to the ticket's or contingent event ticket's creation. Also in the interest of facilitating electronic trading of PSLs, event tickets and contingent event ticket certificates and maintaining accurate ownership records of such products, it is further preferred that only tickets associated with PSLs are traded on the exchange.

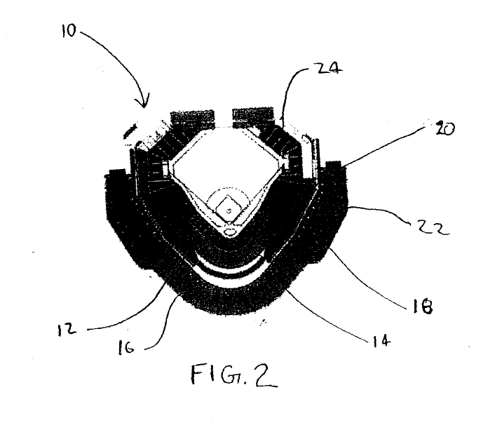

Since each PSL, ticket, and contingent event ticket certificate corresponds to a particular seat within a venue, it is possible to group PSLs, tickets, and contingent event certificates into zones or sections having similar viewing characteristics. For example, referring briefly to FIG. 2, a diagram of a baseball park is shown at 10. The seating areas around the ball park are divided into a patchwork of differently shaded zones. A first zone 12 is shown in the box seat area behind and around home plate. Terrace box seats behind zone 12 form a second zone 14, while a third zone 16 includes the upper deck seats behind home plate. Additional zones 18, 20 and 22 are established in the box, terrace box and upper deck areas respectively along the first and third base lines, and a final zone 24 is established in the bleacher sections and behind the visiting team's dugout. According to an embodiment of the system, seats within the same zone are considered fungible. A person using the present inventive method or electronic exchange to purchase a ticket must specify a zone in which he or she wishes to purchase a ticket. A ticket for any seat within the specified zone will satisfy a purchase request for a ticket within the specified zone.

With reference to FIG. 1, once the PSL, ticket, and contingent event ticket certificate inventory has been distributed, step S2 involves receiving offers to sell and bids to purchase PSLs, event tickets and contingent event ticket certificates. In one embodiment of the system, transactions are settled in real time. Only the actual holders of inventory (PSLs, tickets, and contingent event ticket certificates) can place offers for sale, while any member of the exchange can place bids to purchase. However, other trading rules are possible where a party not holding inventory may be allowed to offer PSLs, tickets or contingent event ticket certificates for sale as long as he or she makes good delivery of the sold products at a specified time and in a specified manner.

Step S3 calls for listing the received offers to sell and bids to purchase inventory. In order to limit confusion and increase the efficiency of the market, not every offer and bid need be displayed. For example, the current market rate for PSLs, tickets or contingent event ticket certificates may be quickly surmised from the best bid and best offer for a particular zone. The most recent transaction for a PSL, ticket or contingent ticket in a given zone may also give further guidance as to the current market price.

Step S4 involves receiving an indication either from a purchaser indicating that he or she accepts one of the listed offers to sell, or from a seller indicating that he or she accepts one of the listed bids to purchase. The party who posted the accepted bid or offer is matched to the party who indicated an acceptance of the bid or offer in step S5. A payment is received from the purchaser and a payment is made to the seller in step S6. Finally, the inventory that is the subject of the transaction, be it a PSL, an individual event ticket (or tickets), or a contingent event ticket certificate (or certificates), is transferred from the seller to the purchaser in step S7.

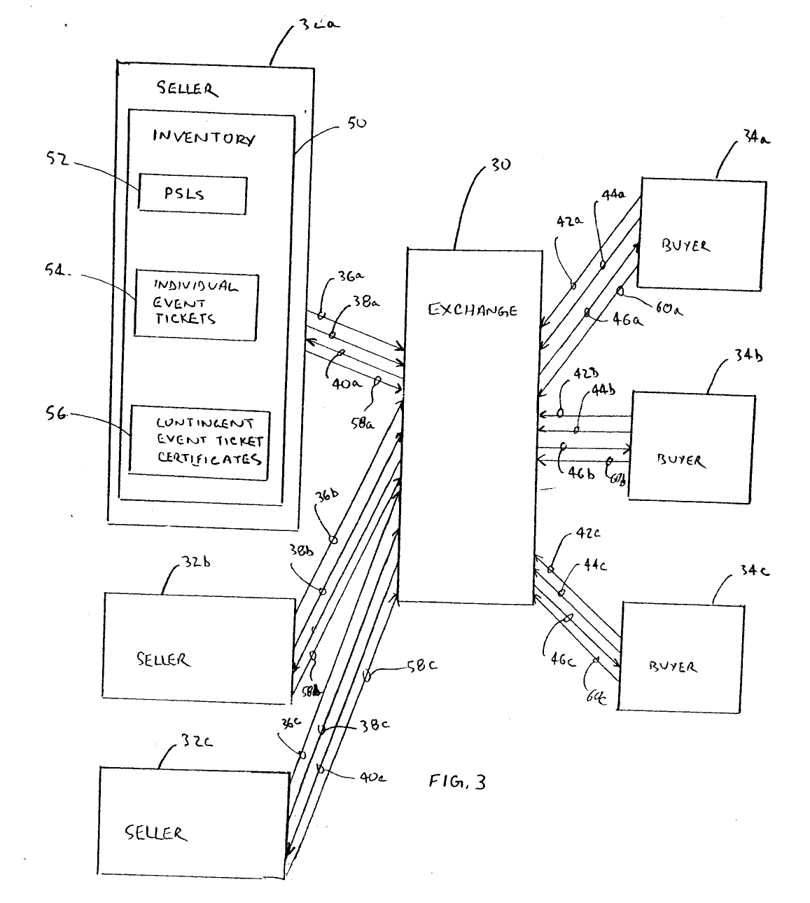

In addition to the method of trading PSLs, individual event tickets, and contingent event tickets just described, another aspect of the system of the present invention further encompasses an exchange for trading PSLs, event tickets and contingent event ticket certificates according to the method just described. One embodiment is shown schematically in FIG. 3. A primary function of the exchange 30 is to list offers to sell and bids to purchase inventory, match the parties making bids and offers with the parties accepting the bids and offers, and exchange the inventory and payment therefrom between the buyers and sellers. Thus, a plurality of sellers 32a, 32b, 32c figuratively “bring” their inventory 48 to the exchange. Three sellers and three buyers are depicted in FIG. 3, however, in reality any number of buyers and sellers may access the exchange 30. A seller's inventory 48 may include one or more each of PSLs 50 individual event tickets 52 and contingent event ticket certificates 54. The sellers 32a, 32b, 32c may list offers to sell items of their inventory on the exchange 30 as indicated by the arrows 36a, 36b, 36c. Typically, such listings would include a description of the inventory item and the offering price. For example, the seller 32a may list four individual event tickets in zone 18 (see FIG. 2) for sale for an August 10 double header between Team A and Team B for $40.00 each.

Buyers 34a, 34b, 34c approach the exchange with no inventory but with cash (or credit i.e., with available funds) in hand to make purchases. The buyers 34a, 34b, 34c may post bids to purchase inventory on the exchange, as indicated by arrows 42a, 42b, 42c. Typically such a posting would include a description of the inventory the buyer wishes to purchase and the amount the buyer is offering to pay. For example, buyer 34a may post a bid for four zone 18 tickets (see FIG. 2) for the same August 10 doubleheader described above, offering to pay $20.00 per ticket. The seller 32a's offer to sell the tickets at $40.00 and the buyer 34a's bid to purchase the tickets at $20.00 are listed on the exchange and are visible to all participants in the exchange, both buyers and sellers. Thus, a market price is established somewhere between $20.00 and $40.00 per ticket for a set of four tickets in zone 18 for the August 10 double header between Team A and Team B.

In addition to listing their inventory for sale at a specific price above the current market price, sellers may alternatively choose to accept a buyer's bid to purchase tickets at the buyer's bid price. Such a transaction is indicated by arrows 38a, 38b, 38c. So, for example, if seller 32a sees buyer 34a's $20.00 bid and decides that it is close enough to what he or she willing to accept for the tickets, seller 32a may accept the offer. Of course, seller 32b, or 32c who may also have inventory equivalent to that being offered by seller 32a (i.e., four tickets in zone 18 for the August 10 doubleheader between Team A and Team B), may under cut the first seller's 32a original $40.00 offering price by either offering to sell their inventory at a lower price, or by accepting a buyer's lower bid price.

A similar process is at work on the buyers' side of the exchange. Buyers may place bids to purchase tickets at prices below those currently offered by the sellers, or buyers may accept sellers listed offers. Such transactions are indicated by arrows 44a, 44b, 44c. If buyer 34a sees seller 32a's $40.00 per ticket offer and decides that he or she is willing to pay that amount to attend the event, buyer 34a may accept seller 32a's offer. Of course, buyers 34b or 34c may also want to attend the August 10 doubleheader and beat buyer 34a to the punch by either accepting seller 32a's $40.00 per ticket offer, or by posting a bid for four zone 18 tickets at a price higher than the $20.00 per ticket offered by buyer 34a seller an offer or bid is accepted the exchange matches the buyer with the seller. Preferably this function is transparent to the parties using the exchange such that the buyer and seller deal only with the exchange, never directly with one another. The exchange receives a payment from the purchaser in at least the amount agreed upon in the transaction (an additional transaction servicing fee may also be required to support the exchange) as indicated by arrows 60a, 60b, 60c. Likewise, the exchange makes payment to the seller in an amount up to the price agreed upon the transaction as indicated by arrows 40a, 40b, 40c. (Again, a transaction servicing fee may be required, and the seller's payment reduced accordingly.) To complete the transaction the inventory being sold must be delivered from the seller 32a, 32b or 32c to the exchange 30, as indicated by arrows 58a, 58b, 58c, and from the exchange to the purchaser 34a, 34b or 34c as indicated by arrows 46a, 46b, 46c.

As will be described more fully below, one preferred embodiment of an exchange system in accordance with the preferred invention is completely electronic. PSLs, event tickets, and contingent event ticket certificates along with ownership records, and the records of exchange participants, and provisions for making and receiving payment are all stored on a database. In this embodiment the act of physically delivering the inventory to the exchange and from the exchange to the purchaser is not required. Nor are the steps of making and receiving payments. Instead, the ownership records of the inventory records are changed to reflect the new owner, and financial accounts may be charged and credited for purchases and sales accordingly.

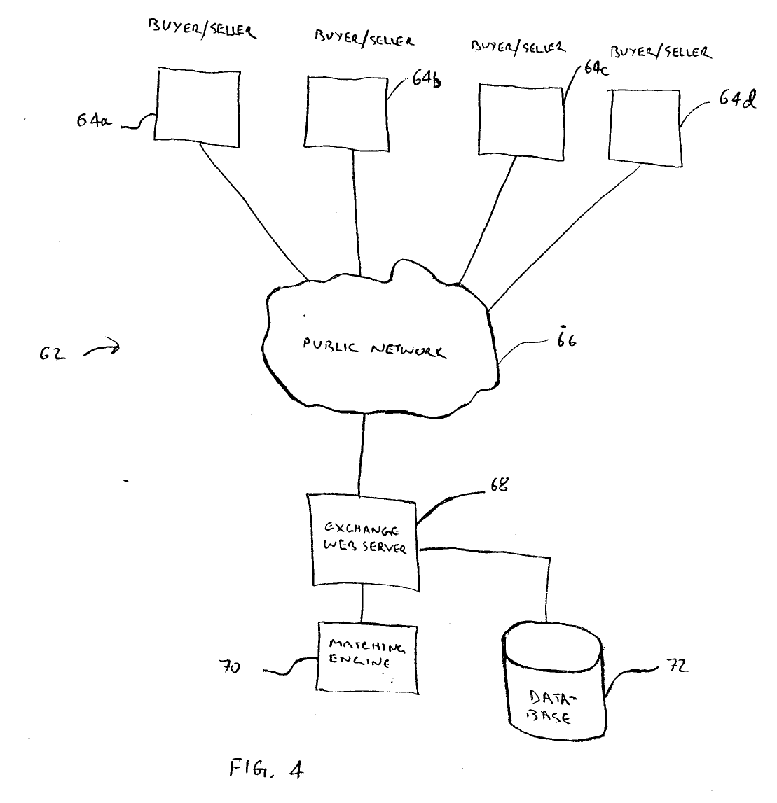

FIG. 4 shows a block diagram of a network-based exchange for trading PSLs, individual event tickets, and contingent event ticket certificates. The exchange 62 includes a number of user terminals 64a, 64b, 64c . . . 64n linked to a ticket exchange web server 68 via a public network 66 such as the World Wide Web. Web server 68, in addition to being connected to public network 66 is functionally connected to exchange software 70 for matching offers and bids with indications of accepting offers and bids, and a database 72 which maintain records of PSLs, tickets and contingent event ticket certificates, who owns them, and how they are traded.

Preferably, only tickets associated with PSLs are traded on the network-based exchange 56. In this embodiment, the tickets associated with the PSLs are wholly creatures of the virtual exchange environment. When an individual purchases a PSL (preferably through the exchange after having registered with the exchange) a record is created in the database 72. If the PSL is not purchased through the exchange, a record of the PSL must be created and stored in the exchange database. When the licensee purchases his or her season tickets each season according to his or her rights under the PSL, the database is updated to reflect this additional inventory. Each individual ticket for each scheduled event is represented in the database and a record of its current owner (initially the PSL licensee) is also stored.

Individuals who do not own PSLs, but who are interested in purchasing tickets on the exchange must first register with the exchange. A database record is created for each registered member of the exchange. As registered customers and inventory holders make purchases and sales, their records are updated to reflect their newly acquired or depleted inventory. Furthermore, a record of each transaction is recorded each time inventory changes hands. Thus, each PSL, event ticket or contingent event ticket certificate will have a complete audit history associated with it so that each owner and each transaction can be identified at a later time. Like PSL owners, customers who have purchased inventory on the exchange may also trade their holdings. Thus, a “ticket” may change hands (virtually) several times before it is finally printed and actually used to gain access to an event.

Contingent event ticket certificates may be treated in a similar manner, or they can be distributed entirely independently of PSLs. In a first alternative, contingent event ticket certificates are created with the season ticket packages purchased by the PSL licensees each season. Thus, in the arrangement the PSL owner is the owner of record for all contingent event ticket certificates associated with the licensed seat at the beginning of each season. For example, a PSL licensee having a license to purchase season tickets for a baseball team's home games would also obtain eleven contingent event ticket certificates, three for the Divisional Playoff series games (assuming a best of five series), four for the League Championship series and four for the World Series, assuming a best of seven format for the League Championship Series and the World Series. These are the maximum number of possible post season home games if the team enjoys home field advantage in each series and if each series extends to the maximum number of games. Of course, the actual number of contingent events scheduled at the team's home venue may actually be much less than eleven depending on the team's performance.

Another alternative for initial distribution of contingent event ticket certificates is to offer PSL licensees a right of first refusal to purchase contingent event ticket certificates. If the PSL licensee does not exercise his or her right to purchase the corresponding contingent event ticket certificates, they may be offered for sale to the highest bidders in an on-line auction conducted on the exchange 62.

Contingent event ticket certificates may also be offered directly to all registered members of the exchange 62. According to this alternative, contingent event tickets are offered in an open auction. Bidding may be scheduled for a set period of time and the member offering the highest bid at the close of bidding is awarded the contingent event ticket certificate for which he or she is bidding in exchange for the winning bid price. Alternatively, contingent event ticket certificates may be initially offered at a predetermined price to any and all registered members of the exchange 62, or may be offered for sale in a forum outside the exchange 62. Members acquiring contingent event ticket certificates are of course free to trade or resell the certificates on the exchange 62.

A note should be made here regarding the payment mechanisms for contingent event ticket certificates. Obviously, if the contingent event ticket certificates are included in the season ticket packages of PSL licensees, the PSL licensee may be charged for the contingent event ticket certificates when he or she pays for his or her season tickets. The same is true if the PSL licensees are offered a right of first refusal to purchase the contingent event ticket certificates. In the open auction model, however, since members of the exchange may be required to submit a valid credit card number (or other financial account from which funds may be drawn) to join the exchange, the financial account of the highest bidder may be automatically charged the bid amount immediately upon the close of bidding. The purchasing member's inventory record may then be updated to reflect the newly purchase contingent event ticket certificate.

However, as described above, it should be appreciated that contingent event ticket certificates need not be associated with PSL licensees or season ticket packages. Accordingly, contingent event ticket certificates may be initially sold or offered to any and all members of the exchange 62 or the electronic marketplace as described in further detail below.

A similar automatic credit card or other financial transaction can be established to take place when contingent event ticket certificates mature into actual event tickets, such as when a team becomes eligible for post season play. Typically an announcement will be made as to when post season event tickets (playoff or championship series games and the like) will go on sale. This date, or some other arbitrary date, can be established as the date on which contingent event ticket certificates for a contingent event which is subsequently scheduled mature into actual event tickets for the newly scheduled event. Whoever is the holder of a contingent event ticket certificate on the specified date is charged the face value of the newly scheduled event ticket. Likewise, the inventory record of the owner of the contingent event ticket certificate will be updated to reflect that he or she then owns an actual event ticket rather than a contingent event ticket certificate.

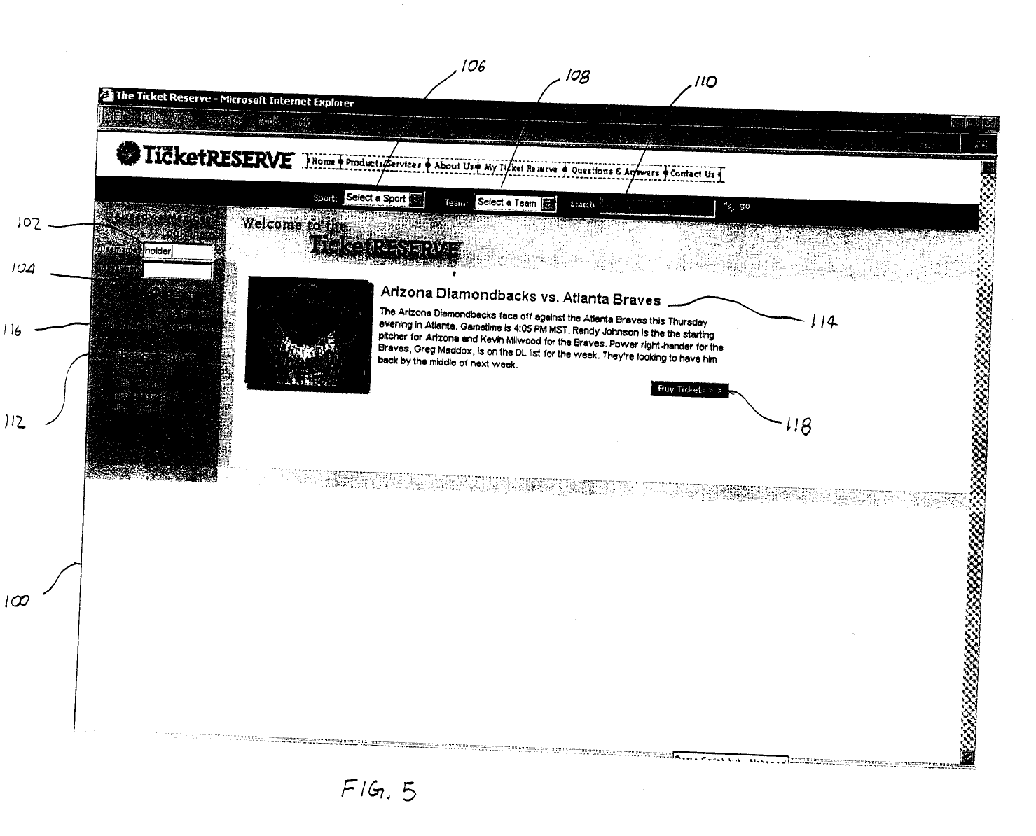

Next, referring to FIGS. 5-21 a graphical user interface for interacting with a network based electronic exchange is described. The graphical user interface is a world wide web based application which is downloadable from the exchange web server 68 (see FIG. 4) as a series of web pages. The web pages forming the graphical user interface may be displayed by a conventional web browser on one or more of the customer terminals 64a . . . 64n.

There are a number of different kinds of users who may access the network based electronic exchange. For example, PSL licensees having excess inventory they wish to sell (e.g., event tickets for events the licensee will be unable or unwilling to attend), aspiring brokers and others desiring to speculate on ticket prices who are willing to purchase and sell inventory without having any intention of actually attending a particular event, and fans who simply want to get the best possible price for tickets to attend a particular event, but who are unable to purchase event tickets in the primary ticket market.

A first scenario will be described wherein a PSL licensee accesses the electronic exchange to sell excess inventory, namely tickets to an event which are associated with one or more PSLs. A next scenario will be described wherein a trader, someone who wants to buy and sell event tickets for profit, purchases the event tickets from the PSL licensee described above. Finally, a fan's purchase of the tickets offered by the broker will be described. Upon completing the transaction, the fan will print out a pair of ticket coupons for his or her own use, and send another pair of tickets to a friend. It should be noted that the parties described in the transactions below are not fixed in their roles.

Fans may purchase some tickets for the purpose of attending the underlying event, or they may plan on trading some of their holdings. Brokers, in addition to buying and selling tickets may also attend some of the events and PSL holders may buy and sell additional tickets which are not associated with their PSLs, and may also actually attend events.

When a customer first accesses the exchange, a login page 100 shown in FIG. 5 is sent to the customer's computer and is displayed by the customer's web browser. The login page typically includes user name 102 and password 106 data entry fields for allowing the customer to log on to the exchange by entering his or her user name and password. The login page 100 may include information on one or more upcoming featured events such as an upcoming baseball game between Arizona and Atlanta as shown. A click-on option 118 to buy tickets to the featured event is also provided. In addition to the featured events 114, the user may also view information on events in different categories. For example, the customer may view different sporting events from a drop down selection menu 106. Alternatively, a customer may browse various events associated with a particular team from the select a team menu 108. A search engine search term entry field 110 is also included on the login page 100. The search engine enables the user to locate and access relevant information on a number of different events by typing in key words, such as a team name, venue, or event name into the search term data entry field 110. A browse sports function 112 is also provided. The browse sports function 112 is similar to the select a sport menu 106 assisting the customer in locating the event he or she is interested in. If the customer accessing the exchange is not a registered member of the exchange, a link 116 is provided to direct the user to a registration page where customer data may be supplied by the customer and recorded by the exchange.

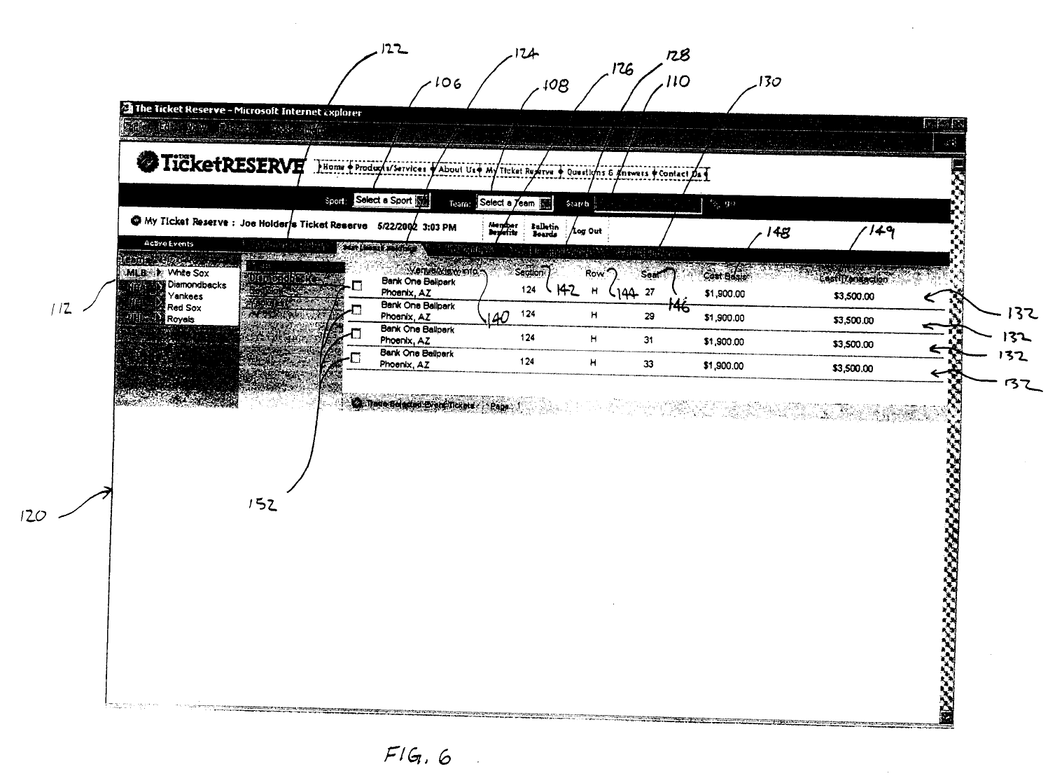

When a registered customer logs onto the exchange by entering a valid user name and password, the exchange recognizes the customer based on the user name, and presents a series of customized pages to the customer's computer reflecting the customer's holdings with the exchange. For example, according to a first scenario, a PSL licensee, Joe Holder, logs on to the exchange. A first customized user page 120 showing Joe Holder's PSL holdings is shown in FIG. 6. A number of features of the initial login page 100, such as the “sport” drop down menu 106, the “Team” drop down menu 108, and the search engine search term data entry field 110 are also displayed on the customized customer pages and are accessible throughout substantially all of the user experience. A series of selectable tabs allow the customer to view various aspects of his or her inventory. Event ticket holdings tab 122 allows the customer to view his or her event ticket holdings. Seat license holdings tab 124 allows the user to view his or her PSL holdings, PTC tab 126 allows the customer to view his or her contingent event ticket certificate holdings. And submitted orders tab 128 and completed orders tab 130, allow the customer to view the orders that he or she has submitted, and those which are have been completed, respectively.

FIG. 6 shows a customized customer page 120 for Joe Holder with the seat license holdings tab 124 selected. In this example, four records 132a, 132b, 132c, 132d are shown corresponding to four PSLs owned by Joe Holder. Each record includes a description of the venue 140, the section 142, row 144, and seat number 146 of the seat associated with the corresponding PSL. The cost basis 148 for the PSL (the cost the current holder of the PSL paid for the PSL) is also displayed, as is the last transaction amount 149 paid for the most recent PSL sold in the same zone as the subject PSL. Each PSL record further includes a check box 152 for selecting the corresponding PSL record to include in a transaction. PSLs and the individual event tickets associated with PSLs may be traded in the same manner. However, because individual event tickets will be traded more often than PSLs, a full description of event ticket trading will be given below, but a description of PSL trading will be omitted.

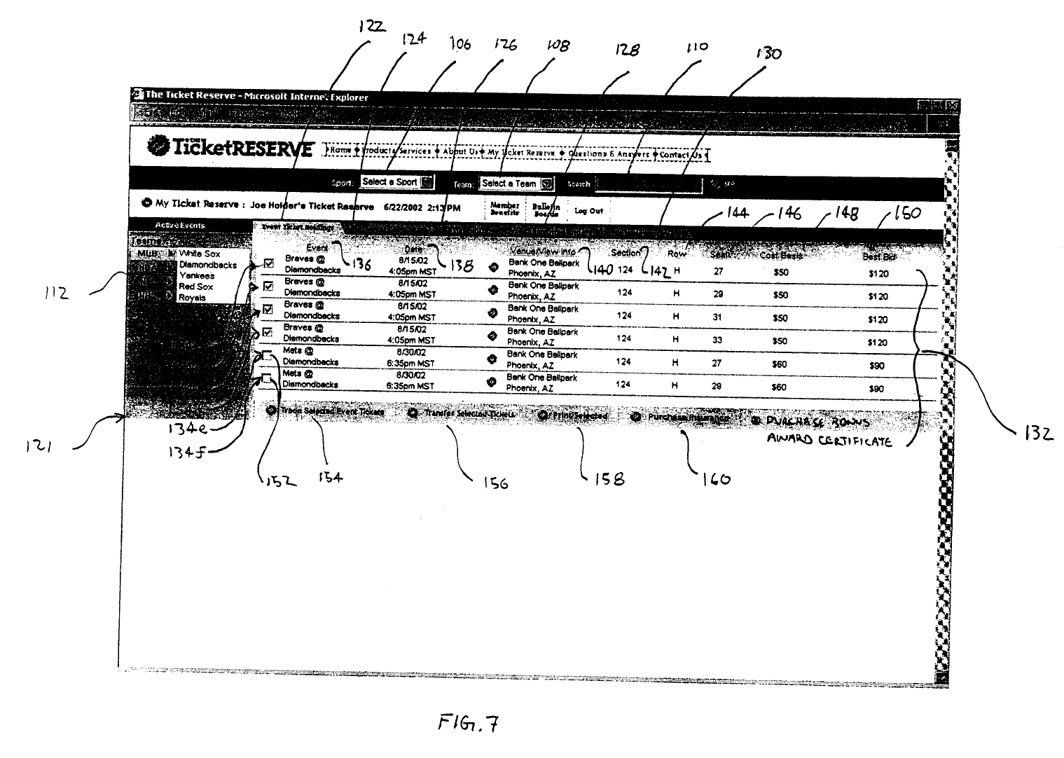

FIG. 7 shows a user customer page 121 for PSL licensee Joe Holder with the event ticket holdings tab 122 selected. This tab shows a listing 132 of event ticket records 134a, 134b, 143c, 134d, 134e, 134f. Each event ticket record includes an event description 136, the event date and time 138, the venue 140, the section row and seat numbers 142, 144, 146, the cost basis of the ticket 148 (the price paid for the ticket by the current owner), and the current best bid 150 for a ticket for a seat located in the same zone as the seat associated with the ticket. Additional pages may be provided to show the customer's additional holdings. Check boxes 152 are provided adjacent each record to allow the customer to select individual tickets for trading or other purposes. The event ticket holdings page 121 also provides click-on customer options such as Trade Selected Event Tickets 154, Transfer Selected Tickets 156, Print Selected Ticket 158, and Purchase Ticket Insurance 160.

If the ticket holder, Joe Holder, wishes to sell certain of his ticket holdings, he selects the corresponding ticket record 134 by mouse clicking the check box adjacent the ticket description. A check mark appears in the selected boxes as shown. In this example, PSL licensee, Joe Holder, has selected four tickets for the Braves v. Diamondbacks game on Aug. 15, 2002 at 4:05 MST at Bank One Ballpark. The tickets correspond to section 124, Row H, Seats, 27, 29, 31, and 33. The ticket holder then selects the “Trade Selected Event Tickets” option 154, in order to offer the selected tickets for sale.

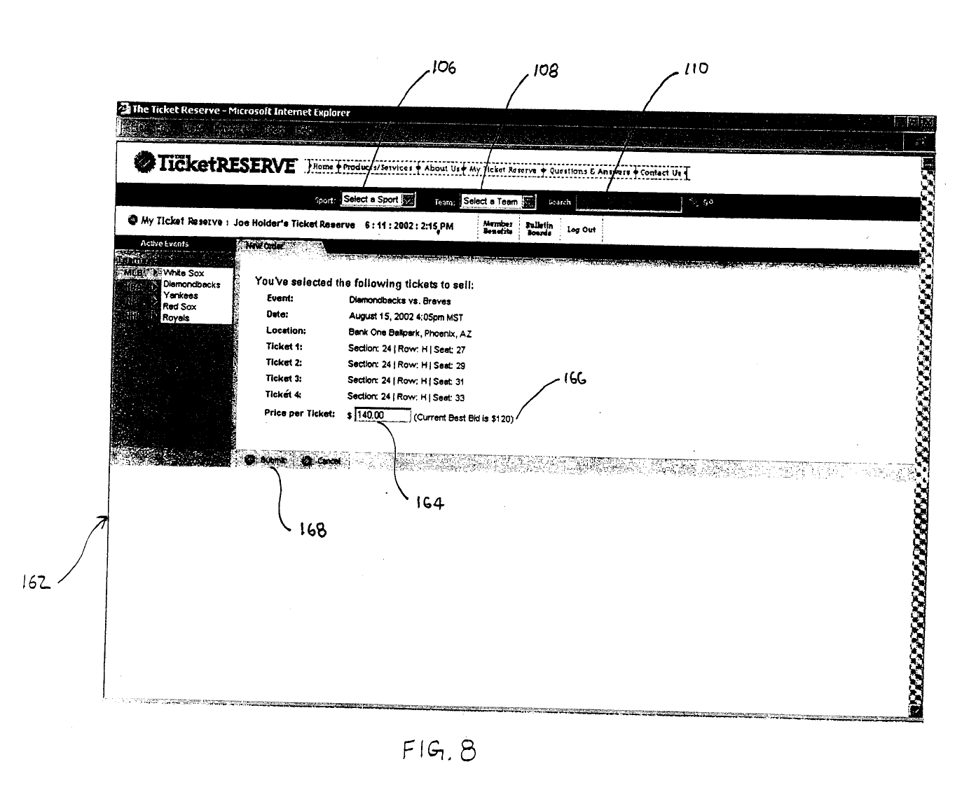

Mouse clicking on the “trade selected event tickets” option 154 causes a new order page 162 to be displayed on the customer terminal, as shown in FIG. 8. As can be seen, the new order page displays the event, the date, and location of the event, as well as the section, row and seat number designation of the tickets to be offered for sale. The new order page also includes a “Price per Ticket” field 164 where the ticket holder may enter the price at which he or she is offering to sell the subject tickets. In the example shown, Joe Holder, has entered $140.00 as the sale price for the selected tickets. A current best bid field 166 displays the current best bid that has been made for tickets located in the same zone as the tickets being offered by Joe Holder. This gives the ticket holder a sense of the market value of the tickets he or she is offering for sale. In this case, the best bid is $120.00 per ticket. Thus, Joe Holder is offering his tickets at $20.00 above the current market price. The ticket holder submits the sell tickets order by mouse clicking on the Submit option 168.

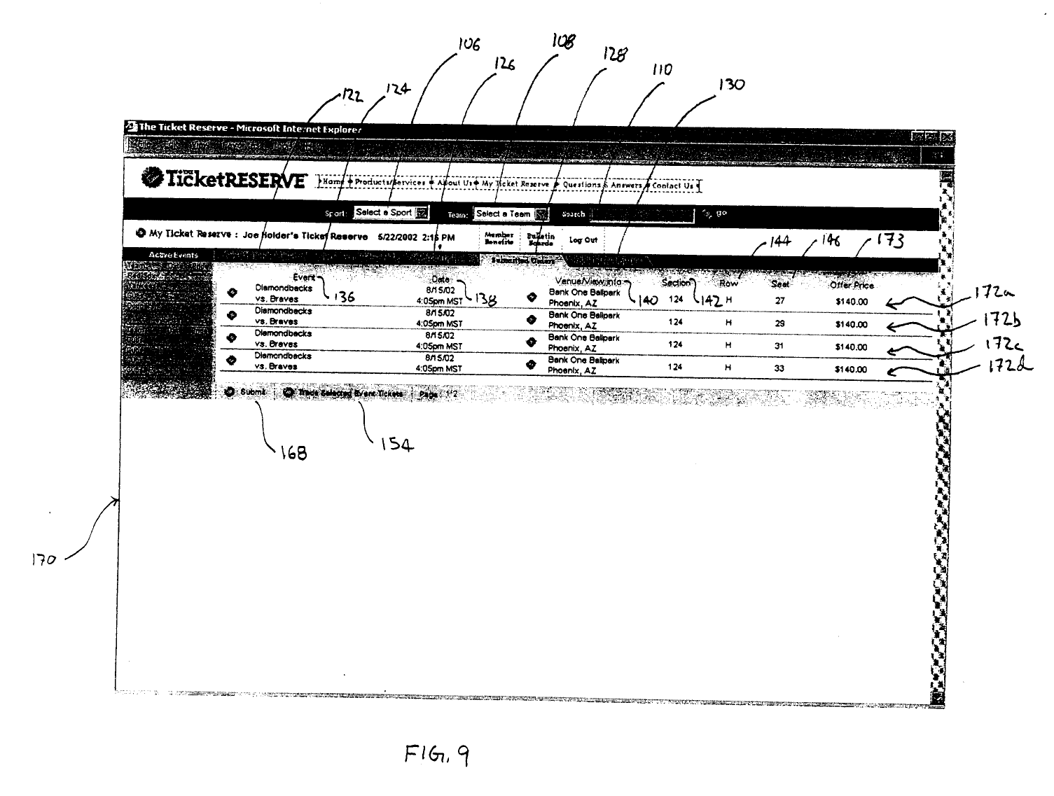

Upon submission of the sell order, the graphical user interface returns to the customized user page showing the user's ticket holdings. The ticket holder may then view the submitted order by selecting the “Customer Submitted Orders” tab 128. The data displayed under the “submitted orders” tab 128 is shown at 170 in FIG. 9. In keeping with the present example, ticket records 172a, 172b, 172c, 172d corresponding to the ticket records 134a, 134b, 132c, 134d selected for sale by Joe Holder in FIG. 7 are displayed. The ticket records 172a, 172b, 173c, 172d are substantially similar to records 134a, 134b, 134c, 134d including the event 136, date 138, venue 14, section 142, row 144, and seat number 146, but rather than including the cost basis 148 and best bid 150, the submitted orders records include the price 173 which the ticket holder entered when he or she submitted the offer, in this case $50.00.

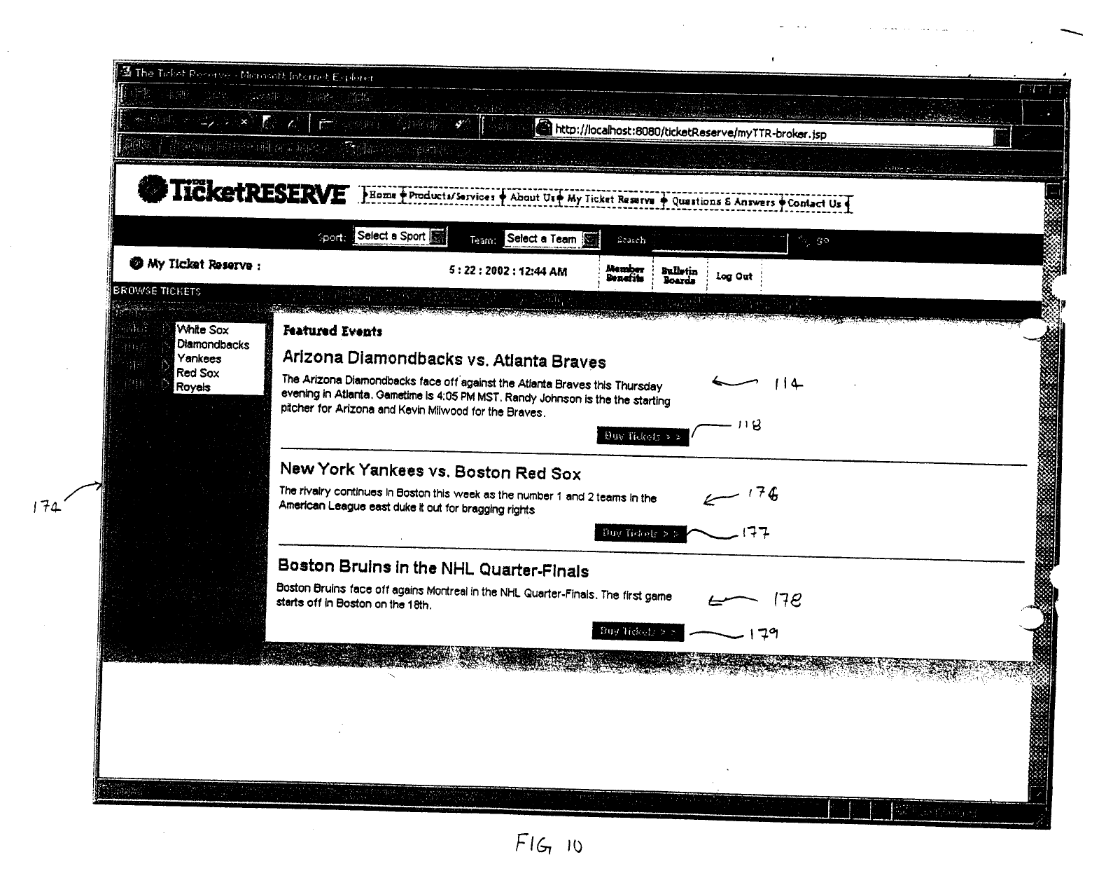

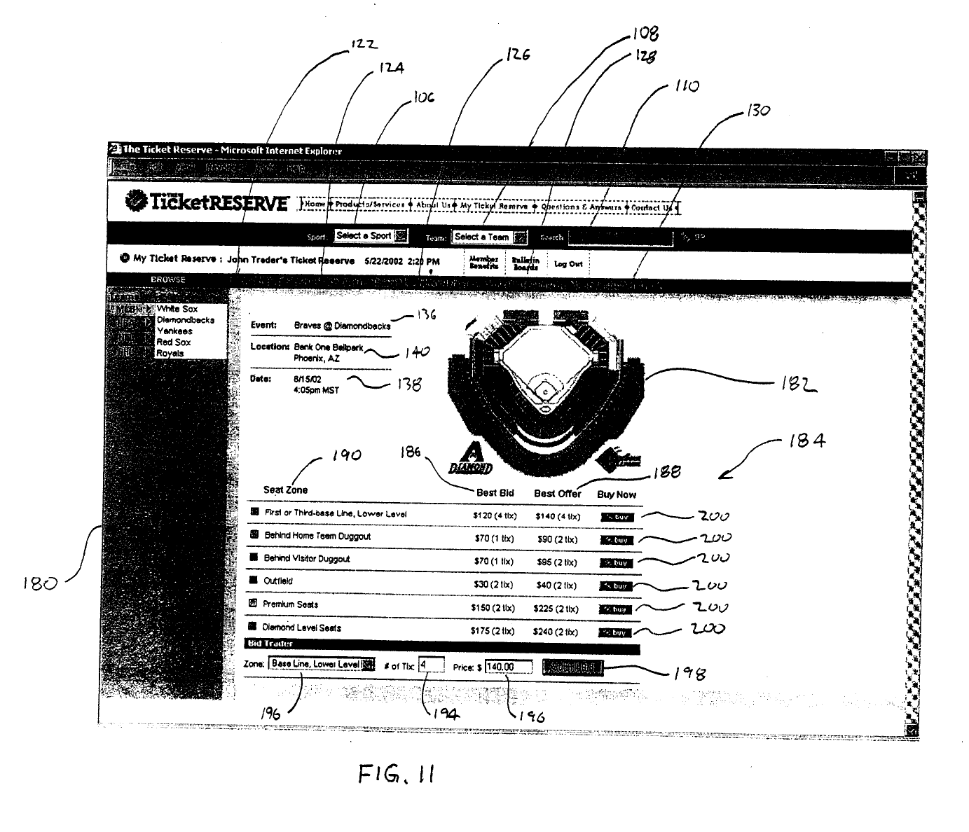

Next, a scenario will be described wherein a customer, John Trader, logs on to the exchange. In this scenario, John Trader holds no PSLs, tickets, or contingent event ticket certificates when he logs on. John Trader's intent is to purchase inventory for one or more popular events in the hope that ticket prices will increase, and that he will be able to re-sell the inventory at a profit. John Trader logs on to the exchange from the login screen 100 of FIG. 5, in the same manner as the PSL licensee in the previous scenario. However, since John Trader has no current ticket holdings, the customized holdings page 174 displayed by his browser and shown in FIG. 10 merely includes additional featured events 176, 178 in addition to the featured event 114 which was also shown on the login page 100. By selecting one of the corresponding Buy Tickets options 118, 177, 179 the customer, John Trader, can access a Purchase Event Ticket screen 180 such as that shown in FIG. 11.

The purchase event tickets screen 180 of FIG. 11 corresponds to customer John Trader selecting the buy tickets option 118 associated with the Arizona Diamond Backs v. the Atlanta Braves featured event 114. Of course, any customer, including John Trader, may arrive at the same screen (or other purchase event ticket screens for other events) by using the browsing function 112 or other navigational tools 106, 108, 110 for locating a particular event.

The purchase event tickets screen 180 lists the event 136, the venue 140 and the date 138. The purchase event tickets screen 180 also includes a map of the venue 182 illustrating the various zones for which tickets are available. A current market conditions table 184 is also displayed. The current market conditions table 184 lists the best bid 186 and best offer 188 for tickets in each seat zone 190 for which tickets are available. The customer can bid on tickets from this page by selecting a zone from a zone drop down selection menu 192, entering the number of tickets he or she wishes to purchase in a number of tickets field 194, entering a bid price in a price field 196, and selecting a submit bid option 198. The customer's bid will subsequently be displayed when other customers view the purchase/sell tickets pages as will be described below. Alternatively, the customer can elect to purchase tickets directly at the current best offer price by selecting the buy option 200 of the desired zone.

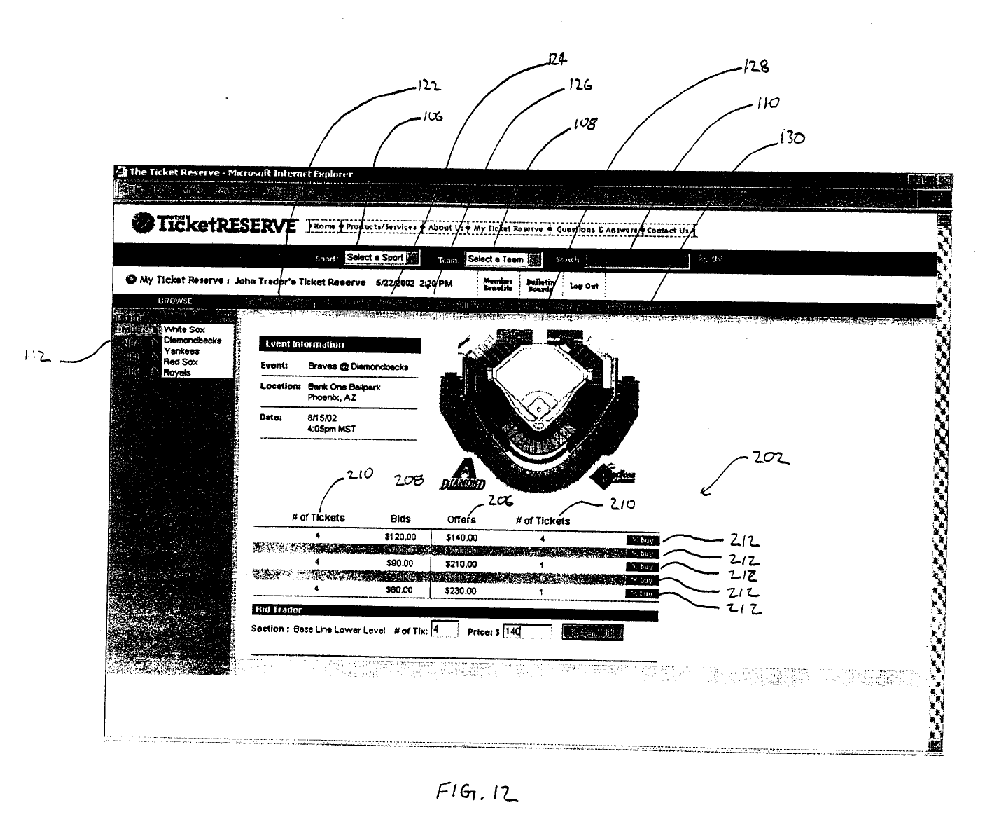

Selecting the buy option 200 adjacent one of the zone entries in the current market conditions table 184 causes a more detailed current market table 202 for the selected zone to be displayed as shown in FIG. 12. The detailed current market table 202 lists all of the offers 206 and bids 208 that have been submitted for tickets in the selected zone for the given event. The number of tickets 210 associated with each bid and each offer is also displayed. The detailed current market table 202 may be all inclusive showing all bids and offers submitted for the respective zone, or it may be limited to a smaller more manageable number of entries. Alternatively, a scroll function may be provided to display additional entries.

In the example shown in FIG. 12 five separate bids and five separate offers are displayed. From this page the customer may again submit a below market bid by entering the number of tickets in the “# of tickets” data field 194 and the price he or she is willing to pay in the “Price” data field 196. The customer submits the bid by selecting the “Submit Bid” option 198. Alternatively, the customer may purchase any of the available tickets by directly accepting a posted offer by selecting the corresponding buy option 212 adjacent the desired offer.

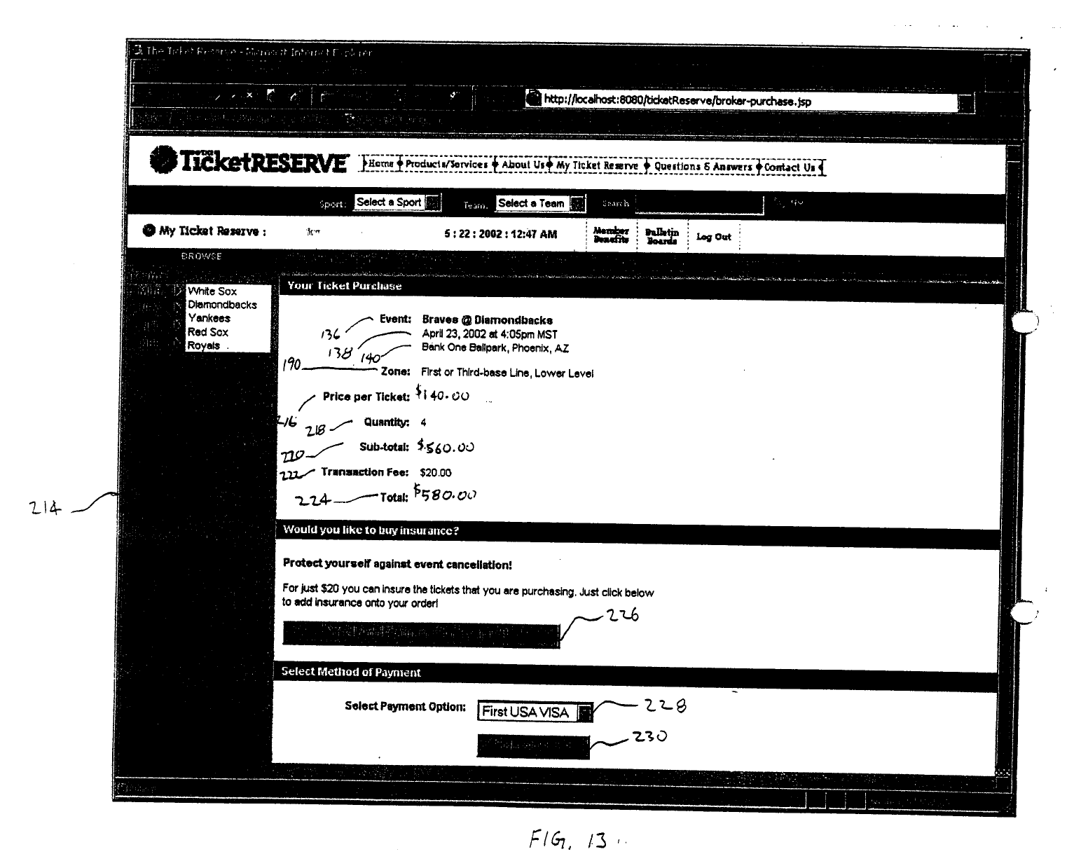

Selecting one of the buy options 212 causes an invoice page 214 to be displayed on the customer's terminal, as shown in FIG. 13. The invoice page 214 displays the event 136, the date 138 and the venue 140, the zone 190 in which the tickets are located, the price paid per ticket 216, the number of tickets 218, the subtotal of the purchase amount 220, a transaction fee amount 222 which may be added by the exchange, and a total amount 224.

The invoice shown in FIG. 13 further provides an option to purchase ticket insurance 226. Ticket insurance is a mechanism that allows the ticket purchaser to insure the price paid for the tickets in the event that the event is cancelled or rescheduled at a time inconvenient for the ticket purchaser. Typically, if the event sponsor cancels an event the event sponsor will only reimburse the face value of the tickets. However, a customer purchasing tickets for a high demand event on the exchange may pay a significant premium over the face value. By purchasing ticket insurance the customer can recoup the full purchase price paid for the tickets if the tickets become worthless or lose their value due to cancellation, rescheduling or the like. Another feature which may be offered to customers of the exchange is a bonus award program based on occurrences that take place at the event. For example, if the event is a baseball game, a customer could purchase a No Hitter Certificate. If a pitcher throws a no hitter in the designated game, the ticket holder who purchased the No Hitter Certificate would then win a prize.

Finally, the invoice page 214 includes a payment option drop down menu 228. The options available on the payment drop down menu will correspond with the payment data supplied by the customer when the customer registered with the exchange (i.e., the financial account, form of payment, etc.). Once the customer has selected a payment option such as Visa or MasterCard or the like, from drop down menu 228 he or she may submit the order by selecting the Submit Order option 230. At this point the customer's selected credit card account is billed the amount total 224 displayed on the invoice 214 at the same time the ownership records of a number of tickets equal to the quantity 218 and within the zone 190 listed on the invoice 214 are updated to reflect the new owner.

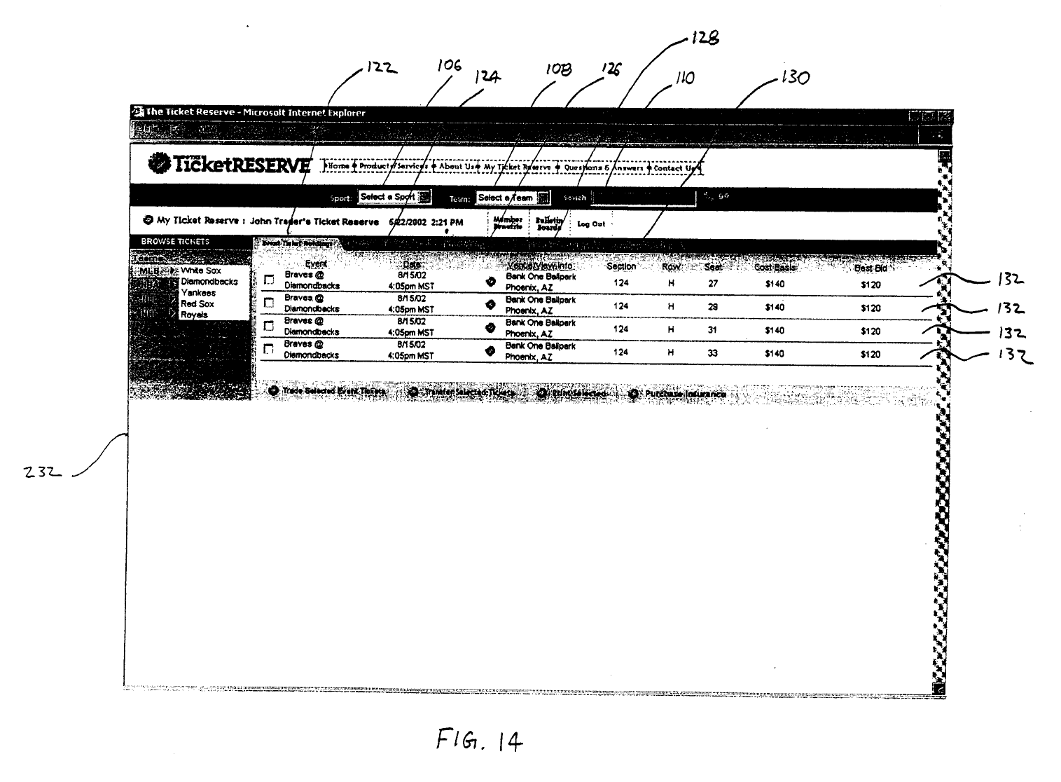

Returning to the example where John Trader is purchasing tickets on the exchange for later re-sale, we will assume that John Trader purchased the four tickets along the first or third baseline for the Aug. 15, 2002 baseball game between the Arizona Diamondbacks and the Atlanta Braves described in the transaction above. John Trader now has inventory. Upon submitting the above order, the exchange's graphical user interface displays John Trader's customized holding page 232 shown in FIG. 14. The four newly purchased tickets are displayed under the event ticket holding tab 122. It will be noted, John Trader's newly acquired ticket holdings are the same tickets which were offered for sale by Joe Holder in the earlier example. Thus, Joe Holder's sell order is now complete. Although not shown, Joe Holder's customer page would no longer display these four tickets under the my holdings tab 122 and a record of the transaction would be displayed under the completed transactions tab 130.

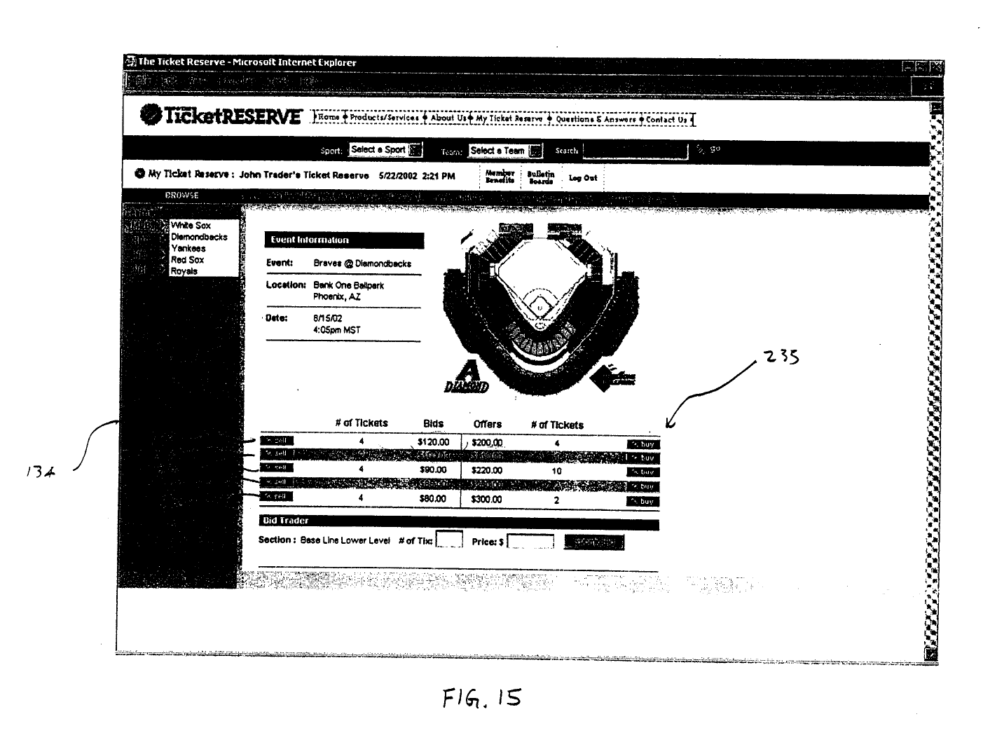

Now that John Trader has inventory, he can turn around and sell the event tickets that he has purchased. John Trader can offer to sell the tickets above the current market price or he can accept a bid from another customer on the exchange. The steps necessary for John Trader to place an above market offer to sell are identical to those described above with regard to Joe Holder's offer to sell his inventory and will not be repeated here. Alternatively, the steps necessary for John Trader to accept a current bid posted by another potential buyer will be described. It should be noted that Joe Holder also could have sold his tickets according to this alternate method. Suppose that Jane Fan has submitted a bid for four tickets to the Aug. 15, 2002, Arizona Diamondbacks v. Atlanta Braves baseball game at Bank One Ballpark, and that she has bid $200 per ticket. John Trader can monitor the market price for his inventory by locating the event or events for which he holds tickets using the navigational tools 106, 108, 110, 112. In the example, John Trader may again locate the Diamondback v. Braves game to display the detailed purchase/sell event tickets screen 234 shown in FIG. 15. The detailed purchase/sell event tickets screen 234 is substantially identical to the detailed purchase tickets screen 201 of FIG. 12, except that the desired zone current market table 235 includes selectable sell options 235 adjacent the current bids. These appear because John Trader now has the appropriate inventory to sell.

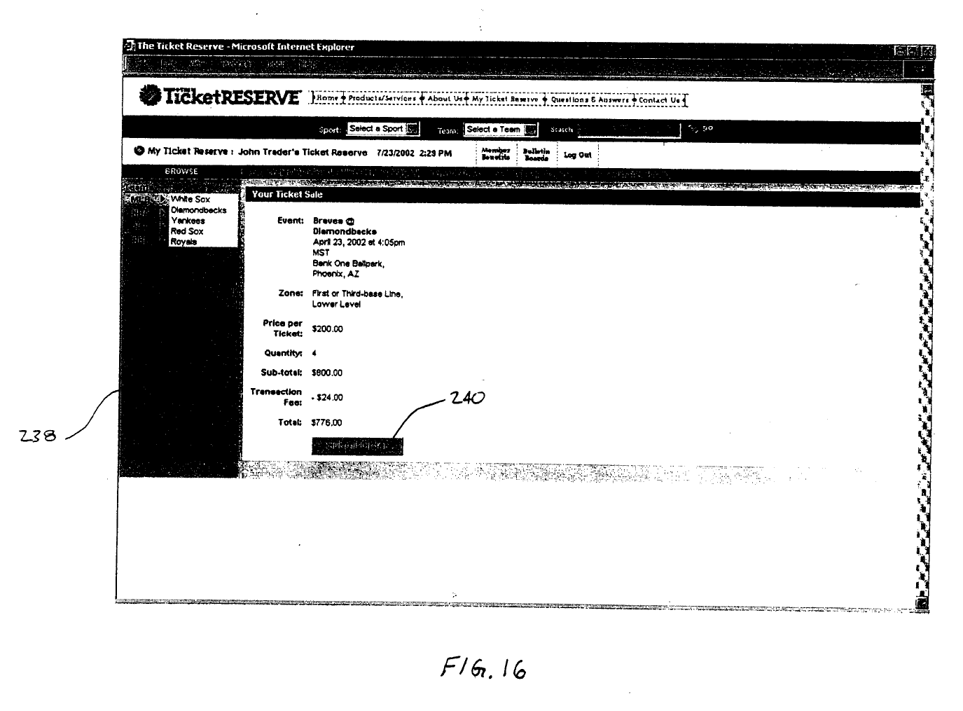

Jane Fan's bid for 4 tickets at $200.00 is currently the best bid. John Trader may accept this bid by selecting the sell option 236 adjacent Jane Fan's bid. Of course, John Holder has no idea of the identity of the party who has submitted the bid. Selecting sell option 236 causes a sales invoice screen 238 to be displayed by John Trader's browser as shown in FIG. 16. Again, the invoice includes the event 136, the date 138, the venue 140, the seating zone 190, the price per ticket 216, the number of tickets 218, a subtotal amount 220, transaction fee 222, and a total amount 224. In this case, the transaction fee is subtracted from the subtotal and the total amount 224 is credited to John Trader's credit card account upon his selecting the submit order option 240.

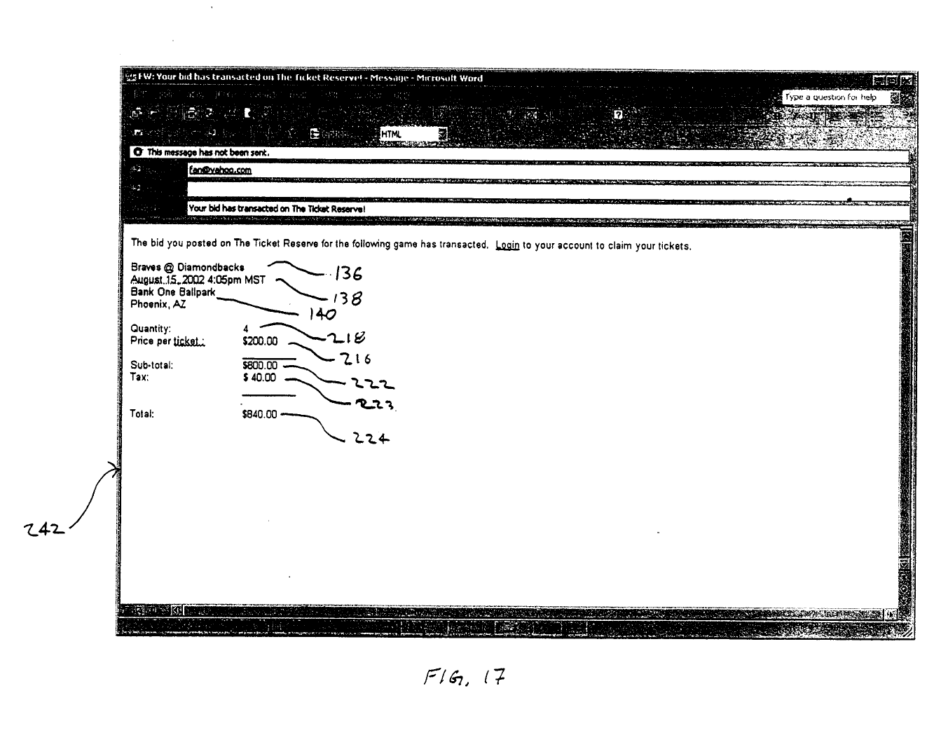

On the purchaser's side, Jane Fan's bid having been accepted, the purchase transaction proceeds automatically. The exchange sends a message to Jane Fan according her preferred method of communication, determined, for example, when she registered with the exchange or when she last updated the communicating method field. For example, the exchange may send an e-mail message 242 as shown in FIG. 17. The message indicates the event 136, the date 138, the venue 140, the price for ticket 216, the quantity 218, the subtotal 222, sales tax 223 and total 224. The total amount is automatically charged to Jane Fan's financial account as registered with the exchange, e.g., a credit card, and the ownership records of the four tickets are updated to reflect the new owner and the audit trail.

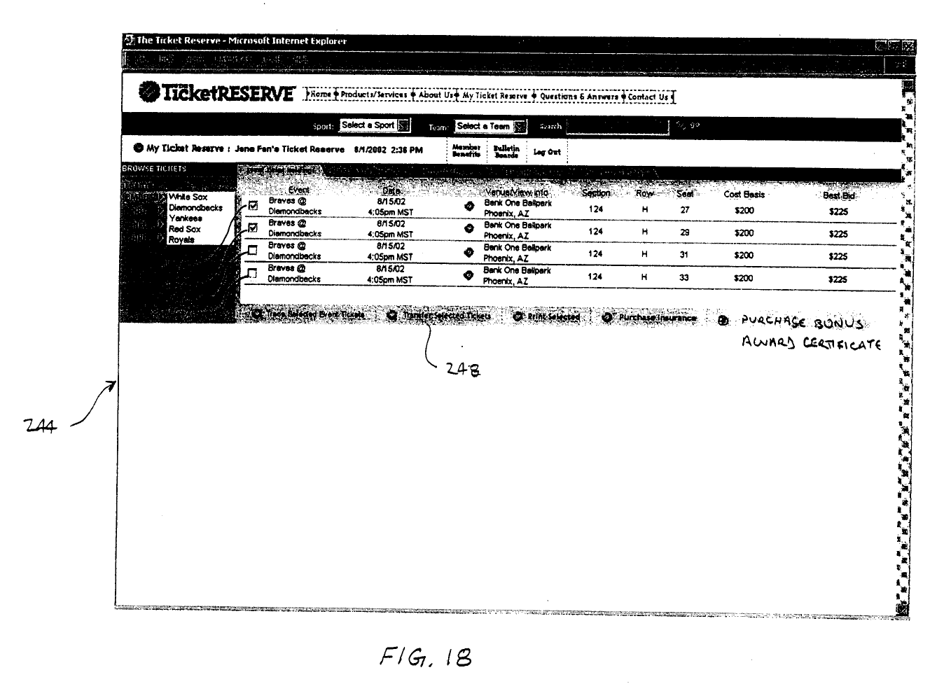

Upon receiving the message 242 Jane Fan may log onto the exchange to view her ticket holdings by accessing her customized user page 244. Her new ticket holdings are displayed under the event ticket holdings tab 122 shown in FIG. 18. As can be seen, Jane Fan's ticket holdings now include the four tickets for the Apr. 23, 2002 Braves-Diamondbacks game at Bank One Ballpark. Since Ms. Fan paid $200.00 per ticket the cost basis is displayed is $200.00. Although not shown, John Trader's ticket holdings at this point would be empty, as he has sold his entire inventory. When viewing her holdings from her customized ticket holdings page 244 Jane Fan can elect to purchase insurance for one or more of her tickets by selecting the check box 152 adjacent to the desired ticket and selecting the purchase insurance option 246. Additional screens (not shown) are provided for transacting a ticket insurance purchase.

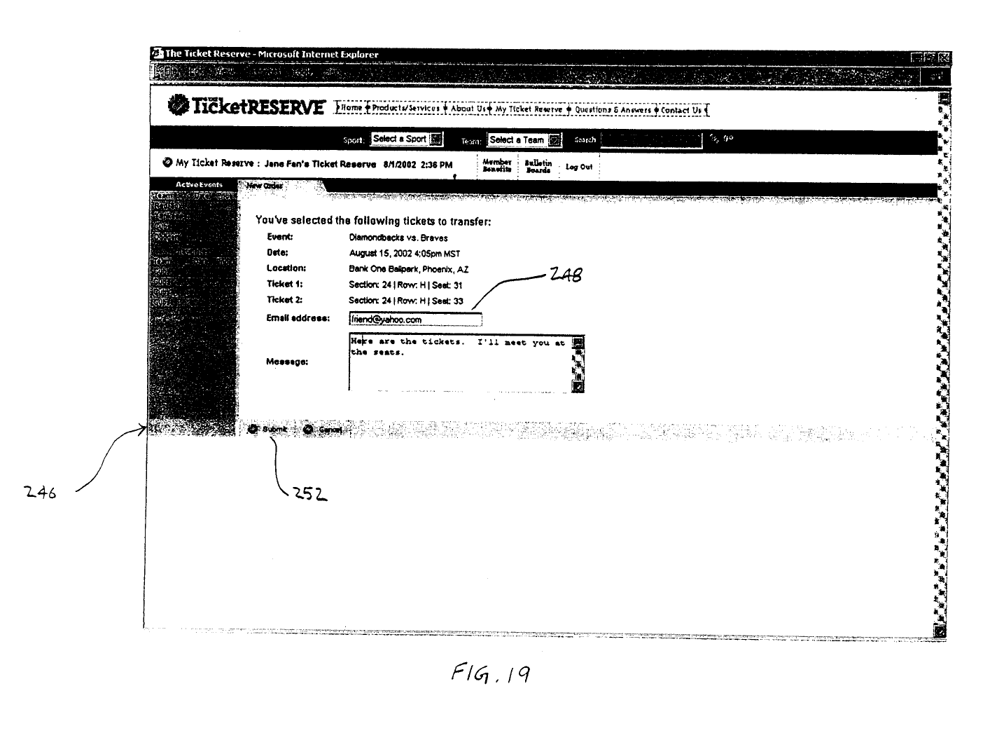

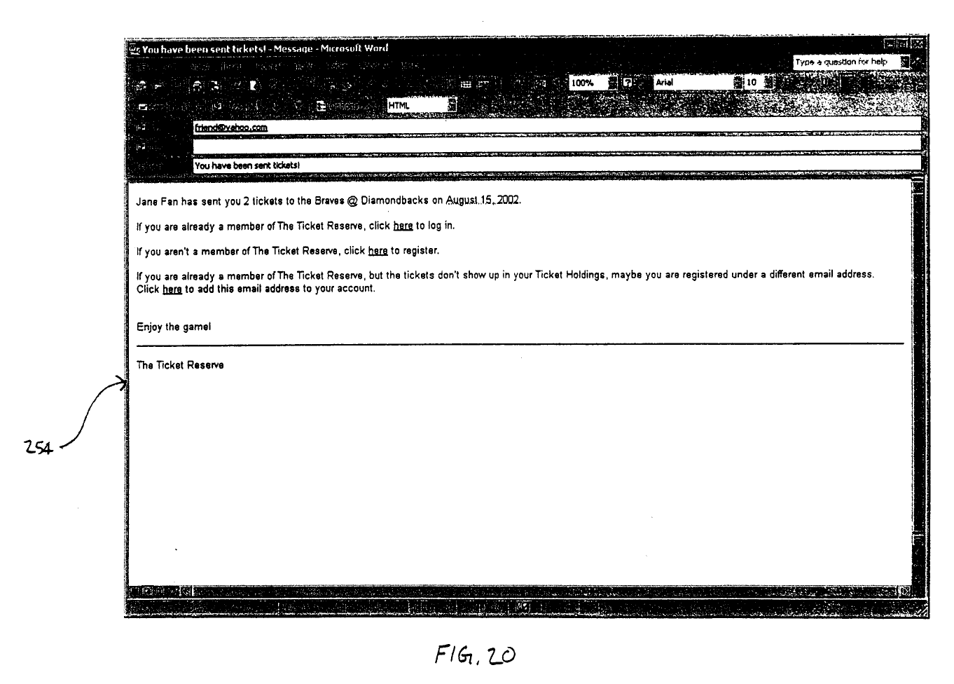

Of course, Jane Fan, having inventory can offer her ticket for sale, accept a bid for the tickets, or actually use the tickets. She may also electronically transfer some or all of her tickets to a friend. To transfer tickets she selects the check box 152 adjacent to the appropriate tickets as shown in FIG. 18, then selects the transfer tickets option 248. This causes the ticket transfer page 246 shown in FIG. 19 to be displayed by Jane Fan's web browser. The ticket transfer page includes the description of the selected tickets, including the event 138, the date 140, the venue 142 and the section row and seat number 144, 146, 148. The transfer ticket page also includes a data field 248 for entering the transferee's e-mail address, as well as a text field 250 for entering a message. Upon selecting the Submit option 252 an e-mail message 254 such as that shown in FIG. 20 is sent to the address entered in the e-mail address field 248. If the transferee is registered with the exchange he or she may login to the exchange to view the transferred tickets and print ticket coupons if he or she intends to use them. If the transferee is not registered with the exchange, he or she must register before being allowed to view and print the transferred tickets.

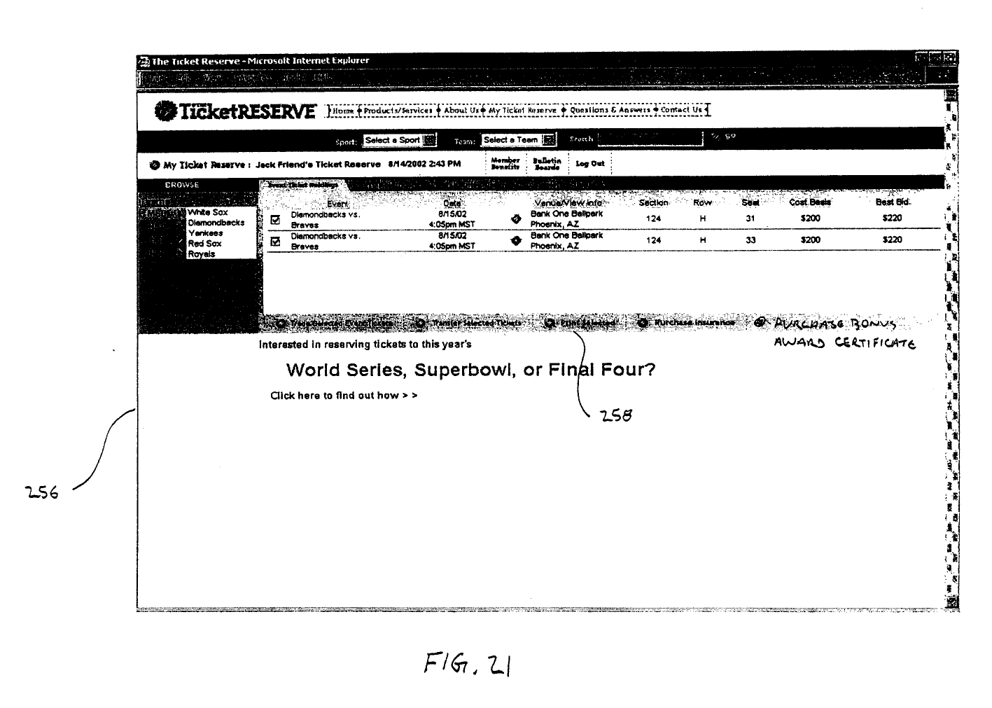

In the example shown, Jane Fan transferred two of her tickets to the Aug. 15, 2002 Braves-Diamondbacks game to her friend, Jack Friend. The transferred tickets correspond to seats 31 and 34, row H, section 124 at Bank One Ballpark. These tickets now appear under the event tickets holdings tab 122 of Jack Friend's customized ticket holdings page 256, as shown in FIG. 21. To use the tickets Jack Friend selects the check boxes 152 adjacent the tickets and selects the print selected option 558. Jack Friend's computer then causes ticket coupons 260 shown in FIG. 21 to be printed. Significantly, the ticket coupons 260 identify Jack Friend as the ticket holder and include bar codes 262 which may include coded encrypted and/or digitally signed data that ensures that the printed ticket is authentic. The ticket coupons identify the event 138, the date 140, the section number 144, row 146 and seat number 148 in the same manner as any conventional ticket. Of course, Jane Fan can print her ticket holdings in the same manner, as can any other event ticket holder.

Finally, it should be noted that contingent event certificates can be traded on the exchange in the same manner as event tickets with the graphical user interface just described. An exchange member's contingent event ticket certificates in this embodiment are more commonly referred to as playoff ticket certificates and may be viewed from the PTC holdings tab 126 of a customer's customized holdings page. Once the contingent event ticket certificates mature into actual event tickets, the records are removed from the customer's PTC holdings tab 126 and are displayed on the event ticket holdings tab 124. Thus, the present system provides an electronic exchange for and a method of trading permanent seat licenses, event tickets and contingent event ticket certificates.

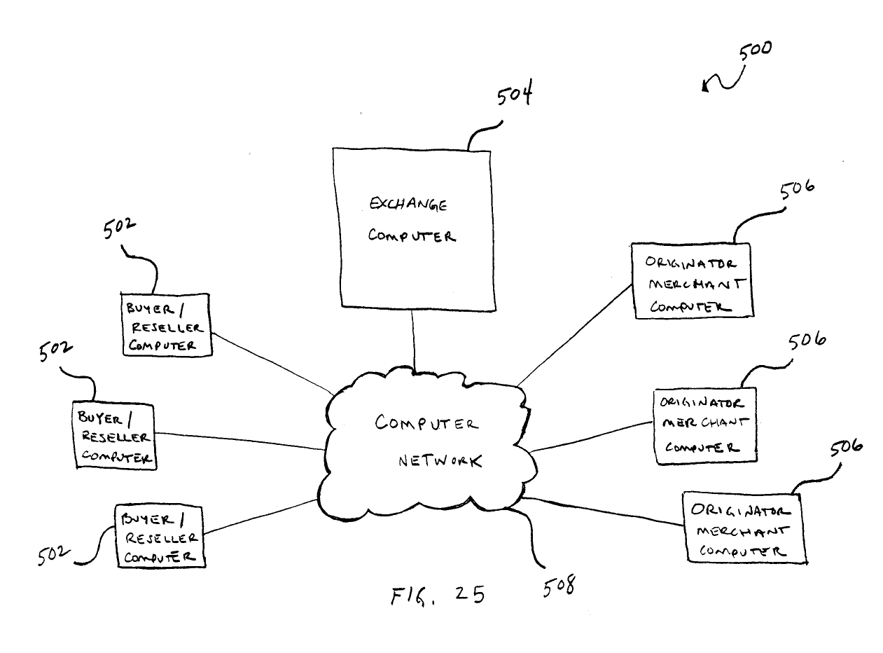

FIG. 25 generally illustrates a block diagram of a system 500 for executing payment transactions. The system 500 includes a number of buyer/seller computers 502, an exchange computer 504 and a number of merchant supplier computers 506. Each of the computers 502, 504 and 506 are interconnected by a computer network 508.

Preferably, the computer network 508 is a public computer network such as the Internet. However, it may also be any suitable computer network including a private subscription computer network. Furthermore, not all of the computers 502, 504 and 506 need to be interconnected via the same type of computer network. For example, the exchange computer 504 and the buyer/seller computers 502 may interconnected via the Internet while the marketplace computer 504 and the originator merchant computers 506 are interconnected via a private limited access computer network.

The buyer/seller computers 502 are configured for use by buyers or sellers desiring to buy or sell items in an electronic exchange created by the system 500. The merchant supplier computers 506 are configured for use by merchants desiring to sell their products via the electronic exchange. The exchange computer 504 enables sellers, including merchant suppliers, to offer items for sale at an offer price set by the seller and to display the item and the corresponding offer price to other participants in the electronic exchange. The exchange computer further enables buyers to accept offers listed on the exchange. When an offer is accepted the exchange computer 504 automatically completes a payment transaction wherein the buyer is charged an amount related to the offer price and the merchant supplier is credited an amount related to the offer price. The exchange computer also causes title to the item to pass from the seller, to the buyer.

In one embodiment, the marketplace computer is further programmed to enable the buyer to become a seller and to re-sell the item on the electronic exchange at a second offer price determined by the buyer. Thus, items can be bought and resold a number of times at varying offer prices on the electronic exchange.

According to various implementations of the present system, the automatic completion of the payment transaction may include, debiting at least one of a credit card, a financial account, or an electronic exchange account of the buyer, and crediting the sellers credit card, financial account, or electronic exchange account. What is more, the automatically completed payment transaction may include an exchange transaction fee charged to either the buyer, the seller, or both the buyer and seller. The exchange transaction fee is preferably retained by the administrator of the electronic exchange to pay for the costs of running the electronic exchange and to generate a profit. The marketplace transaction fee may also include an merchant supplier fee. In this case, a merchant supplier fee is paid to the merchant supplier who is responsible for initially providing the items being traded on the exchange each time an item is sold via the electronic exchange.

The system 500 may be used to sell any items for which there is suitable availability and demand to support a robust trading environment. Preferred markets include tickets, such as event tickets, travel tickets or the like. Also, the items may be contingent event ticket certificates, personal seat licenses, hotel reservations, travel packages, sports or entertainment memorabilia and the like.

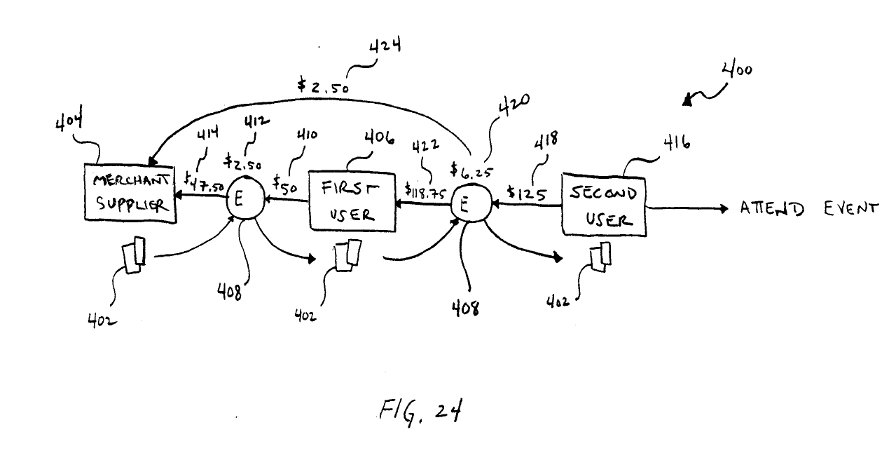

In this regard, FIG. 24 illustrates one example of an electronic exchange transaction stream 400 that includes the sale of event tickets such as for a sporting event. An exchange transaction fee and a merchant supplier fee are included in the transaction. The items being sold are two tickets 402 to the sporting event. The merchant supplier 404 is the sports franchise hosting the sporting event. According to the transaction stream 400, the merchant supplier sells the two tickets 402 to a first user 406 via the electronic exchange 408 at a first purchase price 410 of $50.

As part of the resulting payment transaction, the electronic exchange 408 exacts a first exchange transaction fee 412 which is five percent of the first purchase price 410. Accordingly, the electronic exchange retains five percent of fifty dollars or $2.50 as the first exchange transaction fee 412. The difference between the first purchase price 410 and the first marketplace transaction fee 412 (i.e., a net first purchase price 414) is paid to the merchant supplier 404. Thus, the merchant supplier 404 receives forty seven dollars and fifty cents as the net first purchase price 414. In turn, title to the two tickets 402 passes from the merchant supplier 404 to the first user 406 through the electronic exchange 408.

The first user 406 is now free to attend the sporting event using the two tickets 402 or to resell the two tickets 402 through the electronic exchange 408. Next, assume the first user 406 decides to sell the two tickets 402, and a second user 406 agrees to pay a second purchase price 418 of $125.00 for the two tickets 402.

As part of the resulting payment transaction, the electronic exchange 408 exacts a second exchange transaction fee 420 which is five percent of the second purchase price 418. Accordingly, the electronic exchange retains five percent of one hundred twenty five dollars or six dollars and twenty five cents as the second exchange transaction fee 420. The difference between the second purchase price 418 and the second exchange transaction fee 420 (i.e., a net second purchase price 422) is paid to the first user 406. Thus, the first user 406 receives $118.75 as the net second purchase price 422. In turn, title to the two tickets 402 passes from the first user 406 to the second user 416 through the electronic marketplace 408.

Note, though not a party to this second transaction, the merchant supplier 404 nonetheless is paid an additional merchant supplier fee 424 based on this second transaction. According to this example, the merchant supplier fee 424 is two percent of any subsequent sale 418 or forty percent of the second exchange transaction fee 420. Based on the second sale price of $125.00, the marketplace transaction fee 420 is $6.25 and the merchant supplier fee is $2.50. It should also be appreciated additional marketplace transaction fees and merchant supplier fees are assessed each time the two tickets 402 are sold through the electronic exchange 408. Thus both the electronic exchange and the merchant supplier profit from the activity in the secondary market for the tickets.

After purchasing the two tickets the second user 416 is free to attend the sporting event or to again resell the two tickets 402 through the electronic exchange 408. In the example shown, the second user 406 decides to attend the sporting event.

The tickets may be delivered to the second user 406 by the electronic exchange, either electronically or by conventional means, alternatively the second user 406 may pick up the tickets at the venue as a will call. When tickets are held at will call, the tickets need not actually be delivered to the user before entering the sporting event. For example, a credit card, a confirmation number or an identification number related to the user could be used to secure admission to the sporting event whether at the box office, a ticketing kiosk or at one of the admission gates of the event itself. In addition, the user may be able to print the tickets remotely, for example, over the Internet, and bring the printed tickets to the sporting event as described above. It should also be appreciated that the tickets could be customized to include the name of the user on the face of the tickets as described above. Alternatively, the user might print remotely an indicia of the ticket, such as transaction number (i.e., alphanumeric characters), or a bar code or two dimensional bar or matrix code containing data indications of the transaction and authenticity of ownership such an indicia could be included with or as part of an image of a conventional paper ticket. In addition, the user has the ability to deliver all or a portion of the tickets to a friend, for example, via the Internet as described above.

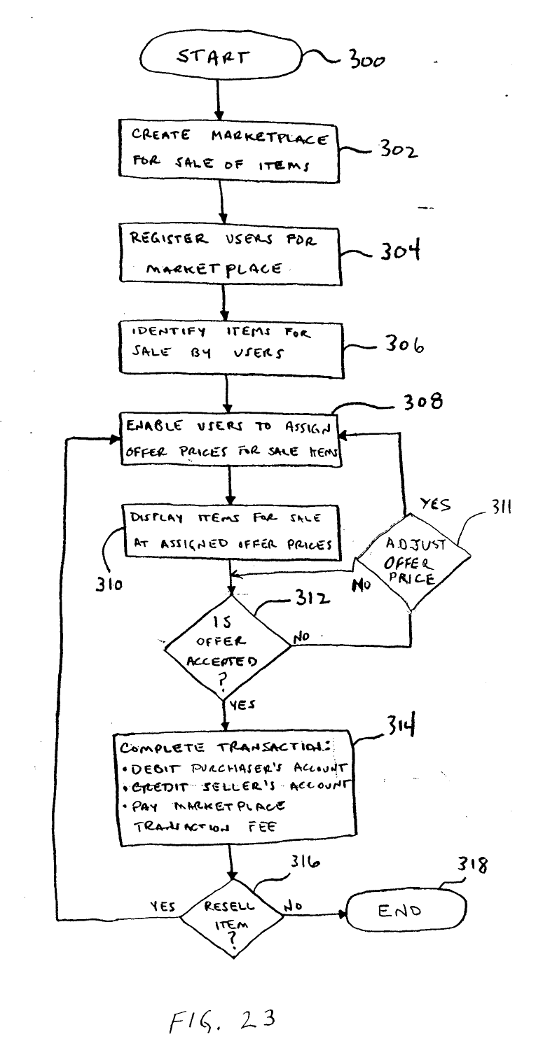

Turning now to FIG. 23, a flow chart is provided illustrating a method for executing an offer based payment transaction in accordance with a preferred embodiment of the present invention. The method begins at step 300. At 302 an electronic exchange for the sale of items is created. In order to buy and sell items in the electronic exchange, a user must be registered with the electronic marketplace. Accordingly, users are registered for the electronic marketplace in step 304.

The electronic marketplace as described herein is substantially similar to the exchange 500 described above in relation to FIGS. 3, 24 and 25. It should be noted, however, that the electronic marketplace may be set up to allow for the sale of items beyond PSLs, event tickets, season tickets and contingent event certificates as described above. Furthermore, the electronic exchange may also include additional features not described above.

Items traded on the exchange may include any suitable items a seller wishes to sell and that a buyer desires to purchase. In one embodiment, the items are tickets such as event tickets or contingent event ticket certificates. In still other alternative embodiments, items may include memorabilia, travel tickets, travel packages, personal seat licenses, and the like.

Once users have been registered for the electronic exchange, items offered for sale by various users are identified in step 306. Users are then able to assign an offer price to their sale items in step 308. Step 306 may be omitted in alternative embodiments where a user enters an item for sale at an assigned offer price, thereby essentially merging steps 306 and 308.

The items offered for sale are then displayed in the electronic marketplace at their respective user-assigned prices as indicated by step 310. Sale items can be displayed in any suitable manner. For example, items could be organized by item type and displayed under categories according to item type. In addition, the displayed items may be searchable to allow users to easily locate items of interest.

At step 312, it is determined whether a seller's offer has been accepted. If the seller's offer has not been accepted, the seller may decide to adjust the offer price at decision block 311. If so, the method returns to step 308 and a new offer price is established. The item will again be displayed at step 310 and a determination made at step 312 whether the seller's adjusted offer has been accepted at step 312. Otherwise, if the seller's offer is not accepted and the seller declines to adjust the offer price, the method continually loops back to decision block 312 waiting for the offer to be accepted (or the price adjusted).

When it is determined at step 312 that a seller's offer price is accepted by a purchaser, a payment transaction is automatically initiated at step 314. The seller thus sells the item at its user-assigned offer price to the purchaser through the exchange. To complete the payment transaction, the seller is credited an amount related to the sale price and the purchaser is charged an amount related to the sale price.

When users register with the electronic marketplace, they may be prompted to enter financial account information from which the user is authorized to either withdraw or deposit funds. Alternatively, the users could enter the financial account information when listing items for sale or when accepting an offer for sale. Thus, the exchange would have the necessary data to debit or credit the user's associated financial account when completing a transaction. More than one financial account may be provided by a given user.

Examples of acceptable financial accounts include credit card accounts, debit card accounts, checking accounts, savings accounts, money market accounts, brokerage accounts and the like. Alternatively, the user could apply for a personal financial account with the exchange. In this case, the electronic exchange would either debit or credit a user's personal account with the electronic exchange when completing the transaction. It could also be arranged that users are required to submit funds up front before opening a personal account with the electronic exchange. In addition, some users might be required to submit additional up front payments if the user's credit rating falls below a predetermined threshold.

In one embodiment, the step of automatically completing the payment or sales transaction also includes paying the exchange transaction fee. As described above, the exchange transaction fee is preferably paid to the administrator of the electronic exchange, generating revenue for the exchange. The marketplace transaction fee may be based on a percentage of the sale or may be a flat fee. Furthermore, the marketplace transaction fee may include a merchant supplier fee which is to be paid by the exchange to the merchant supplier who originally brought the sale items to the exchange to be traded. As described in relation to FIGS. 3, 24 and 25, the merchant supplier is the party that originally produced or created the particular items being sold. For example, where the item being sold is a personal seat license, a contingent event ticket certificate or an event ticket, the merchant supplier would most likely be an event promoter, a venue owner, or a sports franchise. The merchant supplier fee allows the originator of the goods to participate in the secondary market involving his or her goods, opening up a previously non-existent revenue stream for the merchant supplier.

It should be appreciated that the exchange transaction fee and the merchant supplier fee can be subtracted from the offer or purchase price paid to the seller and/or may be added to the purchase price paid by the buyer. Alternatively, the marketplace transaction fee and the merchant supplier fee can be separate fees that are paid apart from the purchase price of the payment transaction.

The method depicted by the flowchart in FIG. 23 further determines at step 316 whether the purchaser would like to resell an item that they just purchased. If the purchaser decides to resell the item at step 316, then the method returns to step 308 where the purchaser (now the seller) is enabled to offer the item for re-sale in the electronic exchange at a user-assigned price. The flow of the method then proceeds as in the embodiment described above. Any given item can be resold any number of different times by a number of different users at a number of different offer prices. If the user decides not to resell the item, then the method ends at step 318.

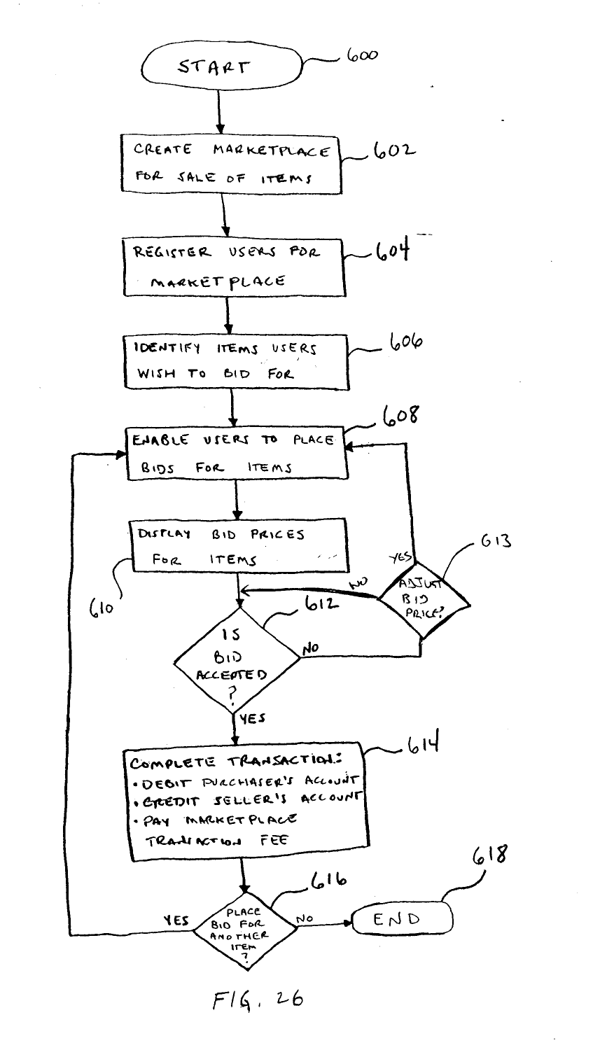

FIG. 26 shows a flow chart of a method for executing a bid based payment transaction in accordance a preferred embodiment of the present invention. The method depicted in FIG. 26 is similar to the offer-driven system described above with reference to FIG. 23. The method begins at step 600. At step 602 an electronic exchange is created for trading items. Again, the items traded on the exchange may be any suitable items for which there is a sufficient supply and demand to sustain a market.

Users are preferably registered for the electronic exchange at step 604. At step 606, a purchaser identifies an item he or she wishes to purchase. The buyer then places a bid for the item in step 608. The desired items are then displayed along with their respective bid prices at step 610. If it is determined at step 612 that a user's bid price has not been accepted, then the purchaser may decide to adjust or modify the bid price as shown by decision block 613. If the purchaser does intend to adjust the bid price the process flows back to step 608 where a new bid corresponding to the purchaser's adjusted bid price is entered. If the purchaser does not want to change his or her bid, the process returns to decision block 612 until either the bid is accepted or the purchaser decides to adjust the bid price.

If it is determined that the bid is accepted at step 612, then a payment transaction is automatically completed wherein the buyer is charged an amount related to the accepted bid price, and the seller is credited an amount related to the accepted bid price, as has already been described. At step 616 it is determined whether the purchaser would like to place a bid for another item. If the purchaser decides to place a bid for another item at step 616, then the method returns to step 608 where the purchaser is enabled to place a bid for another item in the electronic exchange. The flow of the method then proceeds as described above. If the purchaser decides not to place a bid on another item, the method ends at step 618.

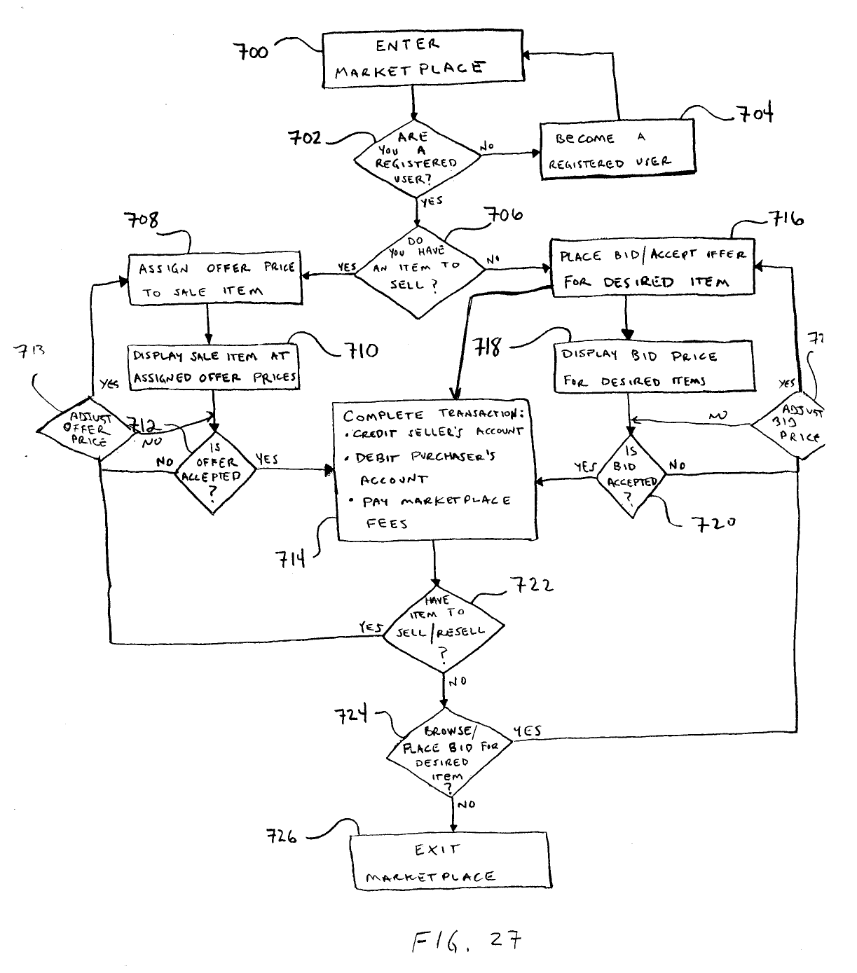

FIG. 27 shows a flow chart that illustrates yet another method for executing a payment transaction in accordance with a preferred embodiment of the present invention. This embodiment includes both bid-driven and offer-driven transactions. The method begins at step 700 when a user enters the electronic exchange. A determination is made at step 702 as to whether the user entering the electronic exchange is a registered member of the exchange. If not, the user must registered at step 704. After registering, the user may reenter the electronic exchange as a registered user at step 700.

Upon determining that the user is registered, a determination is made at step 706 whether the user has an item to sell. If the user indicates that they have an item to sell, the method proceeds to step 708 where an offer driven transaction is initiated. The offer driven transaction is substantially the same as that described in FIG. 23. The user assigns an offer price to the item at step 708, and the item along with the offer price is displayed at step 710. At step 712, it is determined whether the user's offer price has been accepted. If so, at step 714, a transaction is automatically completed as has been described, the buyer is charged and the seller is credited an amount related to the offer amount. If the user's offer price has not been accepted, it may be adjusted by the seller or allowed to remain active as indicated by decision block 713. Returning to step 706, if it is determined that the user does not have an item to sell, the method flows to step 716 where the user may place bids for items or accept offers for items that have been placed by others. Thus the bid-driven side of the method also includes the ability to browse and search existing offers and bids. If the user finds an acceptable bid or offer and accepts the bid or offer, then the intermediate steps of placing bid or making an offer are omitted and a payment transaction is automatically completed at step 714 in the manner described above for the accepted bid or offer.

At step 718, the user's bid price is displayed for the desired item. A determination is then made at step 720 as to whether the user's bid price is accepted. If the user's bid price is not accepted, then the user may decide to adjust the bid price at step 715. If so the method returns to step 716 wherein the user enters a new bid price. Otherwise the existing bid remains active until it is either accepted or until the user decides to change it. If the user's bid price is accepted, at step 720 a payment transaction is automatically completed at step 714 as has been described and title to the item passes from the seller to the buyer.

After completing the payment transaction, a determination is made at step 722 whether the user has any additional items to sell or resell. If so, the method returns to step 708 where the user begins the process of offering an item for sale. If the user does not have any additional items to sell or resell, the process moves to step 724 where it is determined whether the user would like to browse existing bids and offers or place another bid for a desired item. If the user indicates that they would like to continue browsing existing bids and offers or place an additional bid for another item, then the user is returned to the bid-driven side of the method at step 716 and the process repeats.

If the user decides that they do not want to continue browsing or place additional bids, the user then exits the electronic exchange at step 726. Of course, the user is free to enter and exit the electronic exchange as many times as they may wish. In fact, users are encouraged to frequently visit the electronic exchange in order to browse existing bids and offers, offer items for sale, and to place bids for items they desire to purchase. Frequent visits by a number of users increases the likelihood that bids or offers will be accepted by one of the respective users.

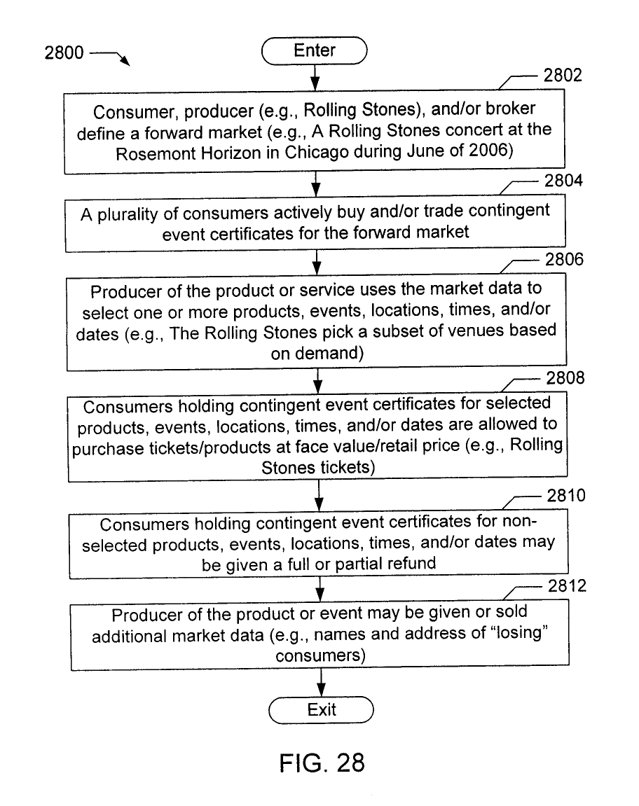

A flow chart of an example process 2800 for predicting demand for an event or product is illustrated in FIG. 28. Preferably, the process 2800 is embodied in one or more software programs which is stored in one or more memories and executed by one or more processors. Although the process 2800 is described with reference to the flow chart illustrated in FIG. 28, it should be appreciated that many other methods of performing the acts associated with process 2800 may be used. For example, the order of many of the steps may be changed, and many of the steps described are optional.

Generally, the process 2800 enables a producer of goods or services (e.g., music concerts, toys, etc.) to predict the demand for the product or service. A futures market is opened up for the particular good or service, and the associated market data is used to predict demand. Although tickets to events such as music concerts are used throughout these examples, it should be appreciated that any product or service may be used.

The process 2800 begins when a forward market for certain goods or services is defined (block 2802). The forward market may be defined by a consumer (e.g., a fan), a producer (e.g., a music group), and/or a broker (e.g., the ticket exchange). For example, the Rolling Stones may announce that they are going to do ten city U.S. tour in 2007. However, as is common practice for these types of announcements, the Rolling Stones do not announce the exact dates and locations for the tour. Instead, they create a plurality of contingent event certificates for a plurality of different dates and locations. For example, the Rolling Stones may create contingent event certificates for twenty different cites with two different dates and venues associated with each city. This example produces eighty different possibilities, even though they only intend to play ten concerts.

In another example, a toy manufacturer may create contingent event certificates for several different lines of toys that will be released in time for the holidays, but may be in short supply. In yet another example, the fans themselves may be allowed to define the market. For example, a fan may want to see Manchester United play the Spanish National team in the new Miami stadium in 2007.

Once these new markets are created, a plurality of consumers may purchase the initial allotment and/or trade the contingent event certificates as described in detail above (block 2804). The initial price of the contingent event certificates could be set at a flat rate, or an auction could be run to set initial market pricing.

The producer of the goods or service may then use the data from this market to select one or more products, events, locations, times, dates, etc. from the possibilities (block 2806). For example, The Rolling Stones may select ten venues based on the level of demand, or a toy manufacturer may decide to produce certain toys in different quantities (or not at all) based on the relative demand levels.

Consumers holding contingent event certificates for products, events, locations, times, dates, etc. that are selected by the producer are allowed to purchase those products/services at retail price (2808). For example, a fan may be allowed to purchase Rolling Stones tickets at face value. Consumers holding contingent event certificates for products, events, locations, times, dates, etc. that are not selected by the producer may be given a full or partial refund (2810). For example, a fan who paid $50 to reserve the right to purchase two Rolling Stones tickets at face value if The Rolling Stones came to Cleveland in the summer of 2007 may be refunded the entire $50. Alternatively, the broker (e.g., ticket exchange) may retain a portion of the fee.

Despite the outcome, the broker may give or sell additional consumer information to the producer (block 2812). For example, the broker may provide the names and address of all the contingent event certificates buyers (even the “losing” ones) to the producer. The producer may use this information for additional marketing campaigns.

Although the examples given herein pertain to music concerts and toys, any suitable market may be established. For example, Andrew Lloyd Webber may issue contingent event certificates for a new production many years in advance. The insight offered by the market data would allow Andrew Lloyd Webber to better understand what his production costs and ticket pricing should be in order to maximize profits.

A type of defined forward market 2802 in process 2800 can be where the venue is known but the performer is unknown. For example, a radio station wants to sponsor a concert in Chicago but they do not know who will perform at the concert. Consumers can purchase options for the performer or performers that they would prefer to see at the concert. The option allows the consumer to purchase an event ticket if the performer or performers of their choice are actually scheduled to perform at the concert.

Another type of defined forward market 2802 in process 2800 can be where the performer is known but the venue or city is not known. For example, Jane Fan can purchase an option to see Cold Play in Chicago. Jane Fan would then have secured the rights, for a given period of time, to purchase an event ticket if Cold Play performs a concert in Chicago. If Cold Play does not perform in Chicago during the given period of time, Jane Fan gets the full or portion of the cost of the option refunded.

Another type of defined forward market 2802 in process 2800 can be where the performer is known, the tour is known (e.g., Manchester United is going to tour United States), but the cities are not known. For example, consumers can purchase options to see Manchester United play in the city of their choice Manchester United can determine the number of cities where there is a sufficient demand to see Manchester United play and play in those cities. Consumers who purchased options for the cities chosen have secured the right to purchase event tickets to see Manchester United. Consumers who purchased options for cities where Manchester United did not play will get a full or partial refund.

Another type of defined forward market 2802 in process 2800 can be where no details about the event are known. The consumers can custom configure an event based on their preferences. The overlap among consumer preferences is then available to event producers and performers which could motivate the event producer to create the event that is in demand.

Another type of defined forward market 2802 in process 2800 can be where the consumer custom configures a dream event. For example, Jane Fan purchases an option to see Cold Play in her college town of Normal, Ill. Cold Play would not usually tour this city but if enough consumers purchase options for Cold Play to perform in Normal, Ill., then Cold Play could schedule a concert for the demand.

In one embodiment of the invention, a consumer creates an event by choosing the details for the event according to their preferences. The consumer then purchases an option for the event created according to their preferences. Other consumers have the ability to buy options to the event created by the first consumer or to create their own event according to their preferences. If a sufficient number of consumers buy options to an event created by a consumer, event producers and/or sellers of the product or service may respond by organizing an event according to the consumer's preferences and the consumers who purchased options would have the opportunity to purchase event tickets. In this manner, the event producer or seller of the product or service responds to the consumers' demand. Thus, the consumer controls the events being produced and organized, and the consumer can choose future events according to their preferences.

Additionally a defined forward market 2802 in process 2800 can be where consumers custom configure other elements associated with contingent events (e.g., play list, opening act, date of performance, time of performance).

It should be understood that various changes and modifications to the presently preferred embodiments described herein will be apparent to those skilled in the art. Such changes and modifications can be made without departing from the spirit and scope of the present invention and without diminishing its intended advantages.

I/We claim:

1. A method of predicting demand, comprising:
receiving information defining a contingent event and a plurality of contingent event certificates associated with said contingent events;
facilitating transactions associating the plurality of contingent event certificates with a plurality of holders to produce market data indicative of demand for said contingent event;
selecting to produce at least one of a product or service based on the produced market data;
supplying each of a first subset of holders of contingent event certificates at least one of a product and a service associated with the contingent event certificate.

2. The method of claim 1, further comprising the step of paying a transaction fee.

3. The method of claim 2, further comprising the step of refunding at least a portion of fee collected from a plurality of holders of contingent event certificate.

4. The method of claim 2, further comprising the step of donating at least part of the fee collected to a charity.

5. The method of claim 1, wherein facilitating transactions associating the plurality of contingent event certificates with a plurality of holders further comprises the step of communicating said transactions over a computer network.

6. The method of claim 1, wherein facilitating transactions associating the plurality of contingent event certificates with a plurality of holders further comprises the step of communicating said transactions through a representative of the plurality of holders.

7. The method of claim 1, further comprising:
collecting information associated with said market data indicative of demand for said contingent event;
communicating information to at least one distributor of product or service associated with the contingent event.

8. The method of claim 1, wherein communicating information to at least one distributor of product or service associated with the contingent event further comprises the step of paying a transaction fee.

9. The method of claim 1, further comprising the step of receiving information regarding travel and transportation associated with said contingent event certificate.

10. The method of claim 1, wherein receiving information defining a contingent event further comprises the step of receiving said information regarding a location for the event.

11. The method of claim 1, wherein receiving information defining a contingent event further comprises the step of receiving said information regarding a date for the event.

12. The method of claim 1, wherein receiving information defining a contingent event further comprises the step of receiving said information regarding a type of event.

13. The method of claim 1, wherein receiving information defining a contingent event further comprises the step of receiving said information regarding a combination of events.

14. The method of predicting demand, comprising:
receiving information from at least one registered user establishing a contingent event;
facilitating transactions associating the plurality of contingent event certificates with a plurality of holders to produce market data indicative of demand for said contingent event;
selecting to produce at least one of a product or service based on the produced market data;
supplying each of a first subset of holders of contingent event certificates at least one of a product and a service associated with the contingent event certificate.

15. The method of claim 14, wherein receiving information from a registered user establishing a contingent event further comprises the step of receiving information from multiple registered users establishing a contingent event.

16. The method of claim 15, further comprising the step of paying a transaction fee.

17. The method of claim 15, further comprising the step of refunding at least a portion of fee collected from a plurality of holders of contingent event certificate.

18. The method of claim 14, further comprising the step of donating at least part of the fee collected to a charity.

19. The method of claim 14, wherein facilitating transactions associating the plurality of contingent event certificates with a plurality of holders further comprises the step of communicating said transactions over a computer network.

20. The method of claim 14, wherein facilitating transactions associating the plurality of contingent event certificates with a plurality of holders further comprises the step of communicating said transactions through a representative of the exchange.

21. The method of claim 14, further comprising:
collecting information associated with said market data indicative of demand for said contingent event;
communicating information to at least one distributor of product or service associated with the contingent event.

22. The method of claim 14, wherein communicating information to at least one distributor of product or service associated with the contingent event further comprises the step of paying a transaction fee.

23. The method of claim 14, further comprising the step of receiving information regarding travel and transportation associated with said contingent event certificate.

24. The method of claim 14, wherein establishing a contingent event further comprises the step of establishing a contingent event based on multiple registered users.

25. An apparatus for predicting demand, comprising:
means for receiving information defining a contingent event and a plurality of contingent event certificates associated with said contingent events;
means for facilitating transactions associating the plurality of contingent event certificates with a plurality of holders to produce market data indicative of demand for said contingent event;
means for selecting to produce at least one of a product or service based on the produced market data;
means for supplying each of a first subset of holders of contingent event certificates at least one of a product and a service associated with the contingent event certificate.

26. The apparatus of claim 25, further comprising the means for paying a transaction fee.

27. The apparatus of claim 26, further comprising the means for refunding at least a portion of fee collected from a plurality of holders of contingent event certificate.

28. The apparatus of claim 26, further comprising the means for donating at least part of the fee collected to a charity.

29. The apparatus of claim 25, wherein facilitating transactions associating the plurality of contingent event certificates with a plurality of holders further comprises the means for communicating said transactions over a computer network.

30. The apparatus of claim 25, wherein facilitating transactions associating the plurality of contingent event certificates with a plurality of holders further comprises the means for communicating said transactions through a representative of the plurality of holders.

31. The apparatus of claim 25, further comprising:
means for collecting information associated with said market data indicative of demand for said contingent event;
means for communicating information to at least one distributor of product or service associated with the contingent event.

32. The apparatus of claim 25, wherein communicating information to at least one distributor of product or service associated with the contingent event further comprises the means for paying a transaction fee.

33. The apparatus of claim 25, further comprising the means for receiving information regarding travel and transportation associated with said contingent event certificate.

34. A method of predicting demand, comprising:
receiving information from at least one registered user establishing an event;
facilitating transactions associating the plurality of contingent event certificates with a plurality of holders to produce market data indicative of demand for said contingent event;
selecting to produce at least one of a product or service based on the produced market data;
supplying each of a first subset of holders of contingent event certificates at least one of a product and a service associated with the contingent event certificate.

35. The method of claim 34, further comprising the step of paying a transaction fee.

36. The method of claim 35, further comprising the step of refunding at least a portion of fee collected from a plurality of holders of contingent event certificate.

37. The method of claim 35, further comprising the step of donating at least part of the fee collected to a charity.

38. The method of claim 34, wherein facilitating transactions associating the plurality of contingent event certificates with a plurality of holders further comprises the step of communicating said transactions over a computer network.

39. The method of claim 34, wherein facilitating transactions associating the plurality of contingent event certificates with a plurality of holders further comprises the step of communicating said transactions through a representative of the plurality of holders.

40. The method of claim 34, further comprising:
collecting information associated with said market data indicative of demand for said contingent event;
communicating information to at least one distributor of product or service associated with the contingent event.

41. The method of claim 34, wherein communicating information to at least one distributor of product or service associated with the contingent event further comprises the step of paying a transaction fee.

42. The method of claim 34, further comprising the step of receiving information regarding travel and transportation associated with said contingent event certificate.

43. The method of claim 34, wherein receiving information from at least one registered user establishing an event further comprises the step of receiving said information regarding a location for the event.

44. The method of claim 34, wherein receiving information from at least one registered user establishing an event further comprises the step of receiving said information regarding a date for the event.

45. The method of claim 34, wherein receiving information from at least one registered user establishing an event further comprises the step of receiving said information regarding a type of event.

46. The method of claim 34, wherein receiving information from at least one registered user establishing an event further comprises the step of receiving said information regarding a combination of events.
